(19) United States
(12) Patent Application Publication
(10) Pub. No.: US 2026/0063876 A1
(43) Pub. Date: Mar. 5, 2026

(54) PHOTOGRAPHING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Jin Sen WANG, Taichung City (TW); Yu-Han SHIH, Taichung City (TW)

(73) Assignee: LARGAN PRECISION CO., LTD., Taichung City (TW)

(21) Appl. No.: 18/932,225

(22) Filed: Oct. 30, 2024

(30) Foreign Application Priority Data
Sep. 4, 2024 (TW) 113133435

(51) Int. Cl. G02B 13/00; H04N 23/55; H04N 23/90

(52) U.S. Cl. CPC G02B 13/0065; G02B 13/0045; H04N 23/55; H04N 23/90

(57) ABSTRACT

A photographing optical lens assembly includes six optical elements which are, in order from an object side to an image side along an optical path: a first optical element, a second optical element, a third optical element, a fourth optical element, a fifth optical element and a sixth optical element. Each of the six optical elements has an object-side surface facing toward the object side and an image-side surface facing toward the image side. The first optical element has positive refractive power. The object-side surface of the first optical element is convex in a paraxial region thereof. The fourth optical element has positive refractive power. The object-side surface of the fourth optical element is convex in a paraxial region thereof.

### RELATED APPLICATIONS

This application claims priority to Taiwan Application 113133435, filed on Sep. 4, 2024, which is incorporated by reference herein in its entirety.

### BACKGROUND

### Technical Field

The present disclosure relates to a photographing optical lens assembly, an image capturing unit and an electronic device, more particularly to a photographing optical lens assembly and an image capturing unit applicable to an electronic device.

### Description of Related Art

With advancements in semiconductor manufacturing technology, the performance of image sensors has improved, allowing for smaller pixel sizes. As a result, optical systems with high image quality have become an indispensable part. As technology continues to evolve rapidly, the range of applications for electronic devices equipped with optical systems has broadened, and the requirements for optical systems have become more diverse. In the past, it was challenging for conventional optical systems to balance the requirements for image quality, sensitivity, aperture size, system volume, and field of view. Therefore, the present disclosure provides an optical system to meet these requirements.

### SUMMARY

According to one aspect of the present disclosure, a photographing optical lens assembly includes six optical elements. The six optical elements are, in order from an object side to an image side along an optical path, a first optical element, a second optical element, a third optical element, a fourth optical element, a fifth optical element and a sixth optical element. Each of the six optical elements has an object-side surface facing toward the object side and an image-side surface facing toward the image side.

Preferably, the first optical element has positive refractive power. Preferably, the object-side surface of the first optical element is convex in a paraxial region thereof. Preferably, the fourth optical element has positive refractive power. Preferably, the object-side surface of the fourth optical element is convex in a paraxial region thereof.

When a central thickness of the first optical element is CT1, a central thickness of the second optical element is CT2, a central thickness of the third optical element is CT3, a central thickness of the fourth optical element is CT4, a central thickness of the fifth optical element is CT5, a central thickness of the sixth optical element is CT6, a focal length of the photographing optical lens assembly is f, a focal length of the first optical element is f1, a curvature radius of the object-side surface of the second optical element is R3, and a curvature radius of the image-side surface of the sixth optical element is R12, the following conditions are preferably satisfied:

$$0.45 < ( CT 2 + CT 3 + CT 4 + CT 5 + CT 6 ) / CT 1 < 1.55 ;$$

$$0. < f / f 1 < 1. ;$$

$$and$$

$$- 10. 00 < ( R 3 + R 12 ) / ( R 3 - R 12 ) < - 1.3 .$$

According to another aspect of the present disclosure, a photographing optical lens assembly includes six optical elements. The six optical elements are, in order from an object side to an image side along an optical path, a first optical element, a second optical element, a third optical element, a fourth optical element, a fifth optical element and a sixth optical element. Each of the six optical elements has an object-side surface facing toward the object side and an image-side surface facing toward the image side.

Preferably, the first optical element has positive refractive power. Preferably, the object-side surface of the first optical element is convex in a paraxial region thereof. Preferably, the fourth optical element has positive refractive power. Preferably, the object-side surface of the fourth optical element is convex in a paraxial region thereof.

When a central thickness of the first optical element is CT1, a central thickness of the second optical element is CT2, a central thickness of the third optical element is CT3, a central thickness of the fourth optical element is CT4, a central thickness of the fifth optical element is CT5, a central thickness of the sixth optical element is CT6, a focal length of the photographing optical lens assembly is f, a focal length of the first optical element is f1, a composite focal length of the fifth optical element and the sixth optical element is f56, a curvature radius of the image-side surface of the first optical element is R2, and a curvature radius of the object-side surface of the fourth optical element is R7, the following conditions are preferably satisfied:

$$0.4 < ( CT 2 + CT 3 + CT 4 + CT 5 + CT 6 ) / CT 1 < 1.6 ;$$

$$0. < f / f 1 < 0.9 ;$$

$$- 3. 0 < f / f 56 < - 0 \text{.65} ;$$

$$and$$

$$0. \leq \vert R 7 / R 2 \vert < 0. 80 .$$

According to another aspect of the present disclosure, an image capturing unit includes one of the aforementioned photographing optical lens assemblies and an image sensor, wherein the image sensor is disposed on an image surface of the photographing optical lens assembly.

According to another aspect of the present disclosure, an electronic device includes at least two image capturing units located on the same side of the electronic device, and the at least two image capturing units includes a first image capturing unit and a second image capturing unit. The first image capturing unit includes one of the aforementioned photographing optical lens assemblies and an image sensor disposed on an image surface of the photographing optical lens assembly. The second image capturing unit includes an optical lens assembly and an image sensor disposed on an image surface of the optical lens assembly.

Preferably, a maximum field of view of the first image capturing unit and a maximum field of view of the second image capturing unit differ by more than 30 degrees.

### BRIEF DESCRIPTION OF THE DRAWINGS

The disclosure can be better understood by reading the following detailed description of the embodiments, with reference made to the accompanying drawings as follows:

FIG. 1 is a cross-sectional schematic view of an image capturing unit according to the 1st embodiment of the present disclosure, corresponding to a diagonal direction of an effective photosensitive area of an image sensor;

FIG. 2 is a cross-sectional schematic view of the image capturing unit according to the 1st embodiment of the present disclosure, corresponding to a short side direction of the effective photosensitive area of the image sensor, with an optical path folded by a first optical element;

FIG. 3 shows spherical aberration curves, astigmatic field curves and a distortion curve of the image capturing unit according to the 1st embodiment;

FIG. 4 is a cross-sectional schematic view of an image capturing unit according to the 2nd embodiment of the present disclosure, corresponding to a diagonal direction of an effective photosensitive area of an image sensor;

FIG. 5 is a cross-sectional schematic view of the image capturing unit according to the 2nd embodiment of the present disclosure, corresponding to a short side direction of the effective photosensitive area of the image sensor, with an optical path folded by a first optical element;

FIG. 6 shows spherical aberration curves, astigmatic field curves and a distortion curve of the image capturing unit according to the 2nd embodiment;

FIG. 7 is a cross-sectional schematic view of an image capturing unit according to the 3rd embodiment of the present disclosure, corresponding to a diagonal direction of an effective photosensitive area of an image sensor;

FIG. 8 is a cross-sectional schematic view of the image capturing unit according to the 3rd embodiment of the present disclosure, corresponding to a short side direction of the effective photosensitive area of the image sensor, with an optical path folded by a first optical element;

FIG. 9 shows spherical aberration curves, astigmatic field curves and a distortion curve of the image capturing unit according to the 3rd embodiment;

FIG. 10 is a cross-sectional schematic view of an image capturing unit according to the 4th embodiment of the present disclosure, corresponding to a diagonal direction of an effective photosensitive area of an image sensor;

FIG. 11 is a cross-sectional schematic view of the image capturing unit according to the 4th embodiment of the present disclosure, corresponding to a short side direction of the effective photosensitive area of the image sensor, with an optical path folded by a first optical element;

FIG. 12 shows spherical aberration curves, astigmatic field curves and a distortion curve of the image capturing unit according to the 4th embodiment;

FIG. 13 is a cross-sectional schematic view of an image capturing unit according to the 5th embodiment of the present disclosure, corresponding to a diagonal direction of an effective photosensitive area of an image sensor;

FIG. 14 is a cross-sectional schematic view of the image capturing unit according to the 5th embodiment of the present disclosure, corresponding to a short side direction of the effective photosensitive area of the image sensor, with an optical path folded by a first optical element;

FIG. 15 shows spherical aberration curves, astigmatic field curves and a distortion curve of the image capturing unit according to the 5th embodiment;

FIG. 16 is a cross-sectional schematic view of an image capturing unit according to the 6th embodiment of the present disclosure, corresponding to a diagonal direction of an effective photosensitive area of an image sensor;

FIG. 17 is a cross-sectional schematic view of the image capturing unit according to the 6th embodiment of the present disclosure, corresponding to a short side direction of the effective photosensitive area of the image sensor, with an optical path folded by a first optical element;

FIG. 18 shows spherical aberration curves, astigmatic field curves and a distortion curve of the image capturing unit according to the 6th embodiment;

FIG. 19 is a cross-sectional schematic view of an image capturing unit according to the 7th embodiment of the present disclosure, corresponding to a diagonal direction of an effective photosensitive area of an image sensor;

FIG. 20 is a cross-sectional schematic view of the image capturing unit according to the 7th embodiment of the present disclosure, corresponding to a short side direction of the effective photosensitive area of the image sensor, with an optical path folded by a first optical element;

FIG. 21 shows spherical aberration curves, astigmatic field curves and a distortion curve of the image capturing unit according to the 7th embodiment;

FIG. 22 is a cross-sectional schematic view of an image capturing unit according to the 8th embodiment of the present disclosure, corresponding to a diagonal direction of an effective photosensitive area of an image sensor;

FIG. 23 is a cross-sectional schematic view of the image capturing unit according to the 8th embodiment of the present disclosure, corresponding to a short side direction of the effective photosensitive area of the image sensor, with an optical path folded by a first optical element;

FIG. 24 shows spherical aberration curves, astigmatic field curves and a distortion curve of the image capturing unit according to the 8th embodiment;

FIG. 25 is a cross-sectional schematic view of an image capturing unit according to the 9th embodiment of the present disclosure, corresponding to a diagonal direction of an effective photosensitive area of an image sensor;

FIG. 26 is a cross-sectional schematic view of the image capturing unit according to the 9th embodiment of the present disclosure, corresponding to a short side direction of the effective photosensitive area of the image sensor, with an optical path folded by a first optical element;

FIG. 27 shows spherical aberration curves, astigmatic field curves and a distortion curve of the image capturing unit according to the 9th embodiment;

FIG. 28 is a cross-sectional schematic view of an image capturing unit according to the 10th embodiment of the present disclosure, corresponding to a diagonal direction of an effective photosensitive area of an image sensor;

FIG. 29 is a cross-sectional schematic view of the image capturing unit according to the 10th embodiment of the present disclosure, corresponding to a short side direction of the effective photosensitive area of the image sensor, with an optical path folded by a first optical element;

FIG. 30 shows spherical aberration curves, astigmatic field curves and a distortion curve of the image capturing unit according to the 10th embodiment;

FIG. 31 is a perspective view of an image capturing unit according to the 11th embodiment of the present disclosure;

FIG. 32 is one perspective view of an electronic device according to the 12th embodiment of the present disclosure;

FIG. 33 is another perspective view of the electronic device in FIG. 32;

FIG. 34 is a block diagram of the electronic device in FIG. 32;

FIG. 35 is one schematic view of an electronic device according to the 13th embodiment of the present disclosure;

FIG. 36 is another schematic view of the electronic device in FIG. 35;

FIG. 37 is one perspective view of an electronic device according to the 14th embodiment of the present disclosure;

FIG. 38 shows a schematic view of inflection points on surfaces of optical elements according to the 1st embodiment of the present disclosure;

FIG. 39 shows a schematic view of Y1R1, ET1, SAG1R1, SAG1R2, SAG5R1, SAG5R2, SAG6R2 and ImgH according to the 1st embodiment of the present disclosure;

FIG. 40 shows a schematic view of P1TL according to the 1st embodiment of the present disclosure;

FIG. 41 shows a schematic view of a shape configuration of an aperture stop of a photographing optical lens assembly according to one aspect of the present disclosure;

FIG. 42 shows a schematic view of a shape configuration of an aperture stop of a photographing optical lens assembly according to another aspect of the present disclosure;

FIG. 43 shows a schematic view of entrance pupil diameters of the photographing optical lens assembly according to one aspect of the present disclosure, corresponding to a long axis direction, a short axis direction and a maximum entrance pupil diameter direction of the aperture stop in FIG. 42;

FIG. 44 shows a schematic view of a structure of a single optical element of a photographing optical lens assembly after edge trimming, according to one aspect of the present disclosure; and

FIG. 45 shows a schematic view of a structure of a single optical element of a photographing optical lens assembly after edge trimming, according to another aspect of the present disclosure.

### DETAILED DESCRIPTION

A photographing optical lens assembly includes six optical elements. The six optical elements are, in order from an object side to an image side along an optical path, a first optical element, a second optical element, a third optical element, a fourth optical element, a fifth optical element and a sixth optical element. Each of the six optical elements of the photographing optical lens assembly has an object-side surface facing toward the object side and an image-side surface facing toward the image side.

The first optical element can have positive refractive power. Therefore, it is favorable for reducing the size of the photographing optical lens assembly and controlling the shooting angle of view. The object-side surface of the first optical element can be convex in a paraxial region thereof. Therefore, it is favorable for reducing the outer diameter of the photographing optical lens assembly. Moreover, the first optical element can be, for example, a prism or a lens element.

The object-side surface of the second optical element can be convex in a paraxial region thereof. Therefore, it is favorable for working with the first optical element to correct aberrations such as spherical aberration.

The fourth optical element can have positive refractive power. Therefore, it is favorable for balancing the refractive power of the front and rear optical elements and converging light to achieve a balance between the image quality and the total track length. The object-side surface of the fourth optical element can be convex in a paraxial region thereof. Therefore, it is favorable for enhancing the ability of the fourth optical element to converge light, thereby shortening the total track length of the photographing optical lens assembly.

The image-side surface of the sixth optical element can be concave in a paraxial region thereof. Therefore, it is favorable for assisting in balancing the back focal length while correcting field curvature to improve image quality.

The first optical element can have an optical path folding function. Therefore, it is favorable for providing different optical path directions for the photographing optical lens assembly, giving the lens more flexible space to achieve the telephoto effect of a long focal length. For example, the first optical element can be a prism.

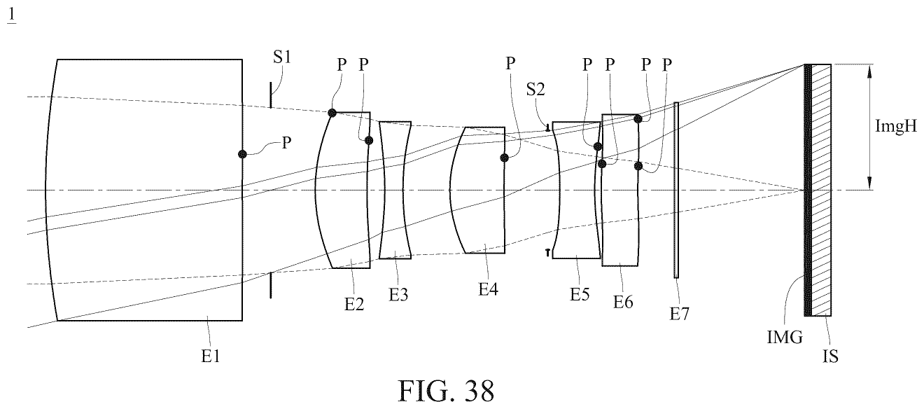

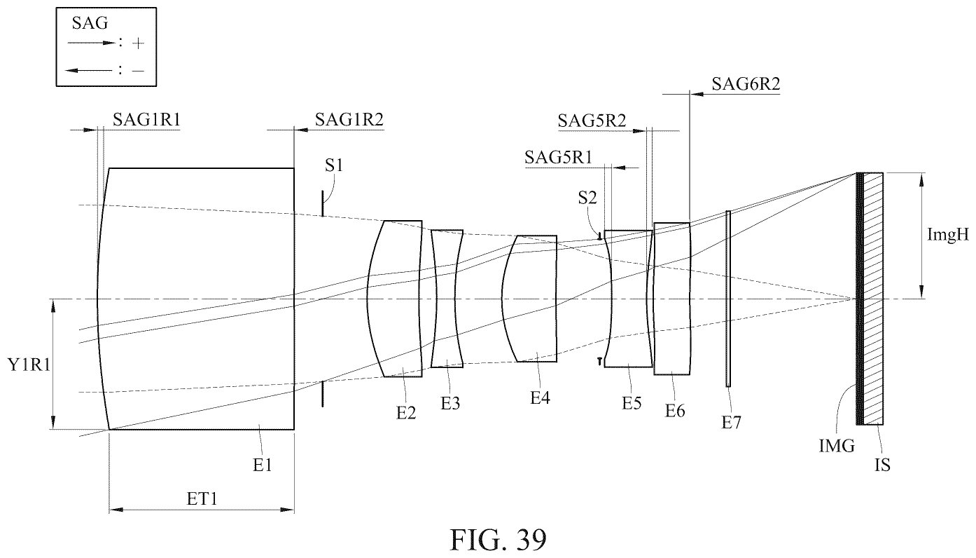

At least one of the six optical elements of the photographing optical lens assembly can have at least one inflection point. In detail, among the first optical element through the sixth optical element, there can be one or more optical elements each having at least one inflection point. An optical element having at least one inflection point refers to that at least one of the object-side surface and the image-side surface of the optical element has at least one inflection point. Therefore, it is favorable for increasing design flexibility and reducing aberrations. Please refer to FIG. 38, which shows a schematic view of the inflection points P on the surfaces of the optical elements according to the 1st embodiment of the present disclosure. In FIG. 38, the image-side surface of the first optical element E1, the object-side surface and the image-side surface of the second optical element E2, the image-side surface of the fourth optical element E4, the image-side surface of the fifth optical element E5 and the object-side surface of the sixth optical element E6 each have one inflection point P, and the image-side surface of the sixth optical element E6 has two inflection points P. The 1st embodiment of the present disclosure shown in FIG. 38 is only exemplary. Each of the optical elements in various embodiments of the present disclosure can have one or more inflection points.

When a central thickness of the first optical element is CT1, a central thickness of the second optical element is CT2, a central thickness of the third optical element is CT3, a central thickness of the fourth optical element is CT4, a central thickness of the fifth optical element is CT5, and a central thickness of the sixth optical element is CT6, the following condition can be satisfied: 0.40<(CT2+CT3+CT4+CT5+CT6)/CT1<1.60. Therefore, it is favorable for controlling the central thickness of the first optical element, allowing the first optical element to have an optical path folding function while taking into account the manufacturing constraints of the first optical element. Moreover, the following condition can also be satisfied: 0.45< (CT2+CT3+CT4+CT5+CT6)/CT1<1.55. Moreover, the following condition can also be satisfied: 0.55< (CT2+CT3+CT4+CT5+CT6)/CT1<1.45. Moreover, the following condition can also be satisfied: 0.78≤(CT2+CT3+CT4+CT5+CT6)/CT1≤1.23.

When a focal length of the photographing optical lens assembly is f, and a focal length of the first optical element is f1, the following condition can be satisfied: 0.00<f/f1<1.00. Therefore, it is favorable for controlling the degree of light convergence at the object-side end of the photographing optical lens assembly for the formation of a telephoto configuration. Moreover, the following condition can also be satisfied: 0.00<f/f1<0.90. Moreover, the following condition can also be satisfied: 0.10<f/f1<0.80. Moreover, the following condition can also be satisfied: 0.33≤f/f1≤0.64.

When a curvature radius of the object-side surface of the second optical element is R3, and a curvature radius of the image-side surface of the sixth optical element is R12, the following condition can be satisfied: −10.00<(R3+R12)/(R3−R12)<−1.30. Therefore, it is favorable for effectively balancing the curvature radius of the object-side surface of the second optical element and the curvature radius of the image-side surface of the sixth optical element to improve the light-gathering quality of the imaging light, while effectively correcting field curvature and reducing spherical aberration. Moreover, the following condition can also be satisfied: −9.00<(R3+R12)/(R3−R12)<−1.40. Moreover, the following condition can also be satisfied: −5.94≤(R3+R12)/(R3−R12)≤−1.63.

When the focal length of the photographing optical lens assembly is f, and a composite focal length of the fifth optical element and the sixth optical element is f56, the following condition can be satisfied: −3.00<f/f56<−0.65. Therefore, it is favorable for adjusting the convergence or divergence of light at the image-side end of the photographing optical lens assembly, thereby facilitating the correction of distortion and field curvature. Moreover, the following condition can also be satisfied: −2.60<f/f56<−0.80. Moreover, the following condition can also be satisfied: −2.06≤f/f56≤−1.09.

When a curvature radius of the image-side surface of the first optical element is R2, and a curvature radius of the object-side surface of the fourth optical element is R7, the following condition can be satisfied: 0.00≤|R7/R2|<0.80. Therefore, it is favorable for effectively controlling the deflection angles of light in the first optical element and the fourth optical element to mutually balance central spherical aberration. Moreover, the following condition can also be satisfied: 0.00≤|R7/R2|<0.60. Moreover, the following condition can also be satisfied: 0.01<|R7/R2|<0.40. Moreover, the following condition can also be satisfied: 0.02≤|R7/R2|≤0.18.

When half of a maximum field of view of the photographing optical lens assembly is HFOV, the following condition can be satisfied: 8.0 degrees<HFOV<20.0 degrees. Therefore, it is favorable for the lens to have an appropriate field of view and for facilitating the formation of a telephoto structure.

When a sum of axial distances between each of all adjacent optical elements of the photographing optical lens assembly is ΣAT, an axial distance between the image-side surface of the sixth optical element and an image surface is BL, and a sum of central thicknesses of all optical elements of the photographing optical lens assembly is ECT, the following condition can be satisfied: 0.40< (ΣAT+BL)/ΣCT<1.60. Therefore, it is favorable for balancing the spatial configuration and ensuring that the photographing optical lens assembly has a sufficient back focal length. Moreover, the following condition can also be satisfied: 0.50< (ΣAT+BL)/ΣCT<1.40.

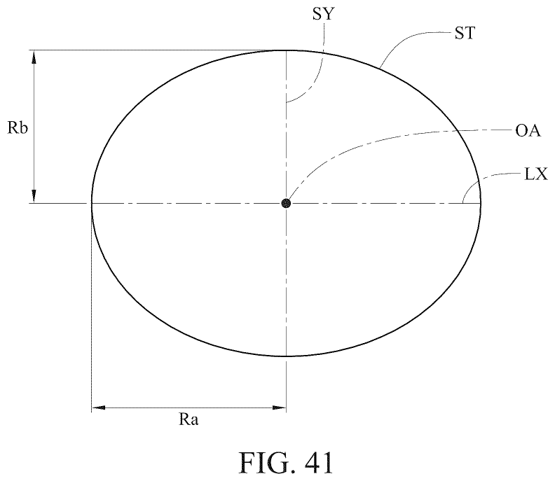

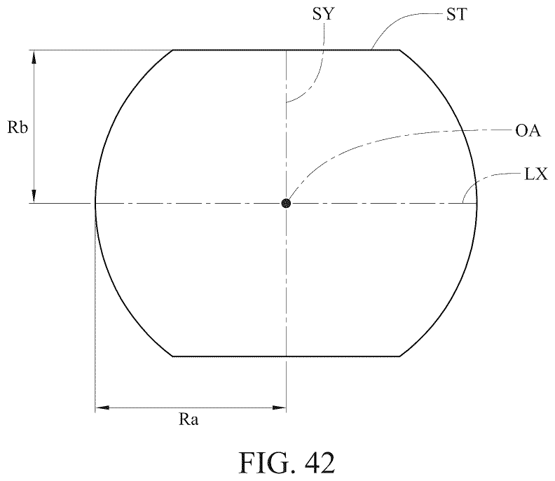

According to the present disclosure, the photographing optical lens assembly can further include an aperture stop. Therefore, it is favorable for controlling the shooting angle of view of the photographing optical lens assembly and ensuring that the lens has an adequate amount of incident light in the telephoto structure. Moreover, the aperture stop can have a major axis direction and a minor axis direction which are perpendicular to an optical axis and different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 41 and FIG. 42, which show schematic views of non-circular aperture stops according to some aspects of the present disclosure, where FIG. 41 shows a schematic view of a shape configuration of an aperture stop of a photographing optical lens assembly according to one aspect of the present disclosure, and FIG. 42 shows a schematic view of a shape configuration of an aperture stop of a photographing optical lens assembly according to another aspect of the present disclosure. As shown in FIG. 41, in some aspects of the present disclosure, a shape of an aperture stop ST is elliptical, and the aperture stop ST has a major axis LX direction and a minor axis SY direction perpendicular to an optical axis OA. The major axis LX direction and the minor axis SY direction are two different directions, and an effective radius Ra of the aperture stop ST in the major axis LX direction is larger than an effective radius Rb of the aperture stop ST in the minor axis SY direction. As shown in FIG. 42, in some aspects of the present disclosure, an aperture stop ST is shaped to have trimmed edges at an outer periphery thereof, and the aperture stop ST has a major axis LX direction and a minor axis SY direction perpendicular to an optical axis OA. The major axis LX direction and the minor axis SY direction are two different directions, and an effective radius Ra of the aperture stop ST in the major axis LX direction is larger than an effective radius Rb of the aperture stop ST in the minor axis SY direction.

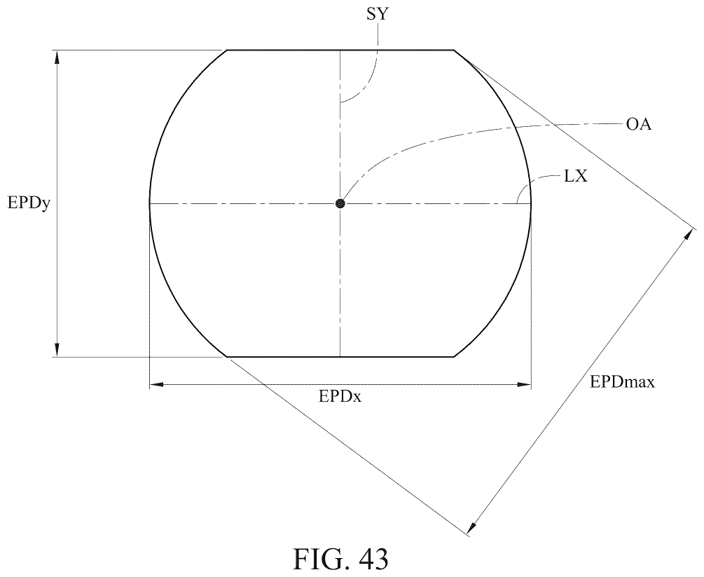

When the focal length of the photographing optical lens assembly is f, and an entrance pupil diameter of the photographing optical lens assembly corresponding to a maximum entrance pupil diameter direction of the aperture stop is EPDmax, the following condition can be satisfied: 1.60<f/EPDmax<3.60. Therefore, it is favorable for achieving a balance between illuminance and depth of field to enhance the telephoto capability of the photographing optical lens assembly. Moreover, the following condition can also be satisfied: 1.80<f/EPDmax<3.30. Moreover, f/EPDmax can refer to an f-number of the photographing optical lens assembly in the maximum entrance pupil diameter direction. Please refer to FIG. 43, which shows a schematic view of EPDmax according to one aspect of the present disclosure. In specific, FIG. 43 shows a schematic view of entrance pupil diameters of the photographing optical lens assembly according to one aspect of the present disclosure, corresponding to a long axis LX direction, a short axis SY direction and a maximum entrance pupil diameter direction of the aperture stop ST in FIG. 42. As shown in FIG. 43, an entrance pupil diameter of the photographing optical lens assembly corresponding to the long axis LX direction of the aperture stop ST is EPDx, an entrance pupil diameter of the photographing optical lens assembly corresponding to the short axis SY direction of the aperture stop ST is EPDy, and an entrance pupil diameter of the photographing optical lens assembly corresponding to a maximum entrance pupil diameter direction of the aperture stop ST is EPDmax.

When the focal length of the photographing optical lens assembly is f, and a composite focal length of the second optical element and the third optical element is f23, the following condition can be satisfied: −2.20<f/f23<0.60. Therefore, it is favorable for adjusting the convergence or divergence of light at the object-side end of the photographing optical lens assembly, thereby facilitating the correction of spherical aberration. Moreover, the following condition can also be satisfied: −1.80<f/f23<0.20.

When the focal length of the photographing optical lens assembly is f, and a focal length of the fourth optical element is f4, the following condition can be satisfied: 0.03<f4/f<1.80. Therefore, it is favorable for the fourth optical element to have stronger positive refractive power to control the total track length while balancing the overall refractive power distribution. Moreover, the following condition can also be satisfied: 0.06<f4/f<1.10. Moreover, the following condition can also be satisfied: 0.15<f4/f<0.90.

When the curvature radius of the image-side surface of the first optical element is R2, and the curvature radius of the object-side surface of the second optical element is R3, the following condition can be satisfied: 0.00≤|R3/R2|<0.30. Therefore, it is favorable for the image-side surface of the first optical element to have a smaller curvature, thereby reducing the generation of spherical aberration and improving manufacturability. Moreover, the following condition can also be satisfied: 0.00≤|R3/R2|<0.25.

When a curvature radius of the object-side surface of the first optical element is R1, and the curvature radius of the object-side surface of the fourth optical element is R7, the following condition can be satisfied: 0.00≤|R7/R1|<1.00. Therefore, it is favorable for the shape of the object-side surface of the first optical element to be coordinated with the shape of the object-side surface of the fourth optical element to adjust the optical path direction, thereby facilitating the formation of a long focal length configuration. Moreover, the following condition can also be satisfied: 0.05<|R7/R1|<0.80.

When the curvature radius of the object-side surface of the fourth optical element is R7, and a curvature radius of the object-side surface of the fifth optical element is R9, the following condition can be satisfied: −2.00< (R7+R9)/(R7−R9)<0.30. Therefore, it is favorable for the shape of the object-side surface of the fourth optical element to be coordinated with the shape of the object-side surface of the fifth optical element, thereby reducing aberrations across different fields of view. Moreover, the following condition can also be satisfied: −1.80< (R7+R9)/(R7−R9)<0.00.

When an Abbe number of the fifth optical element is V5, and an Abbe number of the sixth optical element is V6, the following condition can be satisfied: 0.90<V5/V6<5.00. Therefore, it is favorable for the materials of the fifth optical element and the sixth optical element to be coordinated to correct chromatic aberration. Moreover, the following condition can also be satisfied: 0.90<V5/V6<4.50.

When a refractive index of the fourth optical element is N4, the following condition can be satisfied: 1.450<N4<1.580. Therefore, it is favorable for adjusting the refractive index of the fourth optical element in coordination with the front and rear optical elements to correct chromatic and image aberrations, thereby improving image quality.

When a refractive index of the first optical element is N1, the following condition can be satisfied: 1.500<N1<1.600. Therefore, it is favorable for aligning with the prism design and improving production efficiency by limiting the material selection range of the first optical element.

When a displacement in parallel with the optical axis from an axial vertex of the object-side surface of the first optical element to a maximum effective radius position of the object-side surface of the first optical element is SAG1R1, a displacement in parallel with the optical axis from an axial vertex of the image-side surface of the first optical element to a maximum effective radius position of the image-side surface of the first optical element is SAG1R2, and a distance in parallel with the optical axis between the maximum effective radius position of the object-side surface of the first optical element and the maximum effective radius position of the image-side surface of the first optical element is ET1, the following condition can be satisfied: −0.10< (SAG1R1+SAG1R2)/ET1<0.35. Therefore, it is favorable for adjusting the peripheral thickness and curvature of the first optical element to facilitate the formation of the optical element, thereby improving manufacturability. Moreover, the following condition can also be satisfied: 0.00<(SAG1R1+SAG1R2)/ET1<0.30. Please refer to FIG. 39, which shows a schematic view of SAG1R1 and SAG1R2 according to the 1st embodiment of the present disclosure. When the direction from the axial vertex of one surface to the maximum effective radius position of the same surface is facing towards the image side of the photographing optical lens assembly, the value of displacement is positive; when the direction from the axial vertex of the surface to the maximum effective radius position of the same surface is facing towards the object side of the photographing optical lens assembly, the value of displacement is negative.

When the curvature radius of the image-side surface of the first optical element is R2, the curvature radius of the object-side surface of the fourth optical element is R7, and the curvature radius of the object-side surface of the fifth optical element is R9, the following condition can be satisfied: 0.01< (|R7|+|R9|)/|R2|<2.00. Therefore, it is favorable for balancing the overall optical path of the photographing optical lens assembly, thereby facilitating the correction of astigmatism and reduction of the generation of stray light within the lens. Moreover, the following condition can also be satisfied: 0.03< (|R7|+|R9|)/|R2|<1.80.

When the curvature radius of the object-side surface of the fourth optical element is R7, and the curvature radius of the image-side surface of the sixth optical element is R12, the following condition can be satisfied: 1.60<R12/R7<8.00. Therefore, it is favorable for reducing sensitivity and effectively correcting field curvature. Moreover, the following condition can also be satisfied: 1.70<R12/R7<7.00.

When a maximum effective radius of the object-side surface of the first optical element is Y1R1, and a maximum image height of the photographing optical lens assembly (which can be half of a diagonal length of an effective photosensitive area of an image sensor) is ImgH, the following condition can be satisfied: 0.80<Y1R1/ImgH<1.60. Therefore, it is favorable for effectively controlling the height difference between the first optical element and the image sensor to prevent the lens size from becoming too large. Please refer to FIG. 39, which shows a schematic view of Y1R1 and ImgH according to the 1st embodiment of the present disclosure.

When the central thickness of the first optical element is CT1, and the central thickness of the third optical element is CT3, the following condition can be satisfied: 0.10<10×CT3/CT1<3.00. Therefore, it is favorable for controlling the ratio between the central thickness of the first optical element and the central thickness the third optical element to increase design flexibility and reduce manufacturing tolerances. Moreover, the following condition can also be satisfied: 0.30<10×CT3/CT1<2.50. Moreover, the following condition can also be satisfied: 0.50<10×CT3/CT1<2.00.

When the central thickness of the third optical element is CT3, and the focal length of the photographing optical lens assembly is f, the following condition can be satisfied: 0.15<10×CT3/f<0.60. Therefore, it is favorable for the lens to have an appropriate focal length by adjusting the central thickness of the third optical element. Moreover, the following condition can also be satisfied: 0.20<10×CT3/f<0.55.

When a refractive index of the second optical element is N2, the following condition can be satisfied: 1.420<N2<1.620. Therefore, it is favorable for adjusting the refractive index of the second optical element in coordination with the front and rear optical elements to correct chromatic and image aberrations, thereby improving image quality. Moreover, the following condition can also be satisfied: 1.450<N2<1.580.

When the focal length of the photographing optical lens assembly is f, a focal length of the fifth optical element is f5, and a focal length of the sixth optical element is f6, the following condition can be satisfied: −2.50<f/f5+f/f6<−0.80. Therefore, it is favorable for balancing the refractive power distribution of the photographing optical lens assembly while correcting aberrations, thereby improving image quality.

When a curvature radius of the image-side surface of the fifth optical element is R10, and the focal length of the sixth optical element is f6, the following condition can be satisfied: −0.25<R10/f6<10.00. Therefore, it is favorable for regulating the optical path at the image-side end of the photographing optical lens assembly to improve the light-gathering quality across the entire field of view. Moreover, the following condition can also be satisfied: −0.15<R10/f6<8.00.

When an axial distance between the second optical element and the third optical element is T23, and the central thickness of the second optical element is CT2, the following condition can be satisfied: 0.10<T23/CT2<0.80. Therefore, it is favorable for effectively controlling the distance between the second optical element and the third optical element by the central thickness of the second optical element, thereby improving space utilization and enhancing assembly yield. Moreover, the following condition can also be satisfied: 0.18<T23/CT2<0.70.

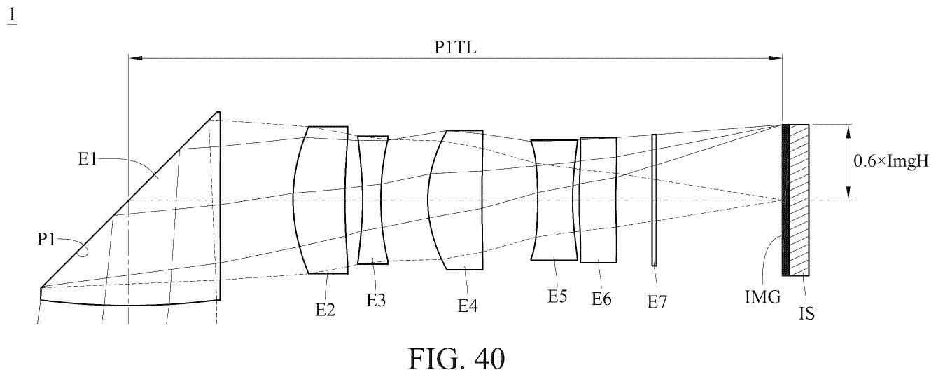

According to the present disclosure, the first optical element can have a reflective surface. When an axial distance between the reflective surface of the first optical element and the image surface is P1TL, and an axial distance between the object-side surface of the first optical element and the image surface is TL, the following condition can be satisfied: 0.70<P1TL/TL<0.95. Therefore, it is favorable for effectively increasing the flexibility of space utilization and reducing the total track length. Moreover, the following condition can also be satisfied: 0.78<P1TL/TL<0.90. Please refer to FIG. 40, which shows a schematic view of P1TL according to the 1st embodiment of the present disclosure. As shown in FIG. 40, the first optical element E1 has a reflective surface P1, and an axial distance between the reflective surface P1 and the image surface IMG is P1TL.

When a displacement in parallel with the optical axis from an axial vertex of the object-side surface of the fifth optical element to a maximum effective radius position of the object-side surface of the fifth optical element is SAG5R1, a displacement in parallel with the optical axis from an axial vertex of the image-side surface of the fifth optical element to a maximum effective radius position of the image-side surface of the fifth optical element is SAG5R2, and the central thickness of the fifth optical element is CT5, the following condition can be satisfied: −1.10< (SAG5R1+SAG5R2)/CT5<0.80. Therefore, it is favorable for adjusting the peripheral curvature of the fifth optical element, thereby facilitating the correction of astigmatism and distortion. Moreover, the following condition can also be satisfied: −0.90< (SAG5R1+SAG5R2)/CT5<0.60. Please refer to FIG. 39, which shows a schematic view of SAG5R1 and SAG5R2 according to the 1st embodiment of the present disclosure. When the direction from the axial vertex of one surface to the maximum effective radius position of the same surface is facing towards the image side of the photographing optical lens assembly, the value of displacement is positive; when the direction from the axial vertex of the surface to the maximum effective radius position of the same surface is facing towards the object side of the photographing optical lens assembly, the value of displacement is negative.

When a displacement in parallel with the optical axis from an axial vertex of the image-side surface of the sixth optical element to a maximum effective radius position of the image-side surface of the sixth optical element is SAG6R2, and the central thickness of the sixth optical element is CT6, the following condition can be satisfied: −0.50<SAG6R2/CT6<0.80. Therefore, it is favorable for effectively controlling the peripheral curvature of the image-side surface of the sixth optical element to adjust the incident angle of light entering the image surface and improve the response efficiency of the image sensor. Moreover, the following condition can also be satisfied: −0.40<SAG6R2/CT6<0.60. Please refer to FIG. 39, which shows a schematic view of SAG6R2 according to the 1st embodiment of the present disclosure. When the direction from the axial vertex of one surface to the maximum effective radius position of the same surface is facing towards the image side of the photographing optical lens assembly, the value of displacement is positive; when the direction from the axial vertex of the surface to the maximum effective radius position of the same surface is facing towards the object side of the photographing optical lens assembly, the value of displacement is negative.

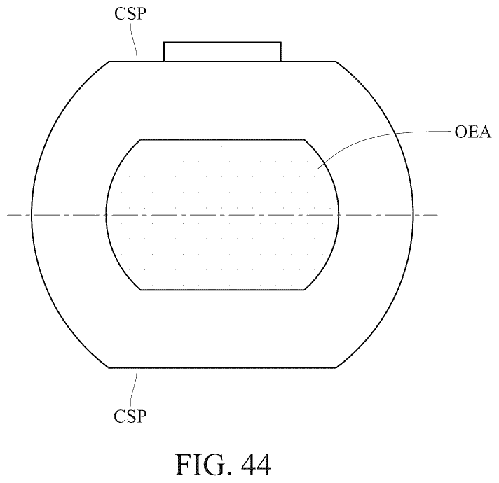

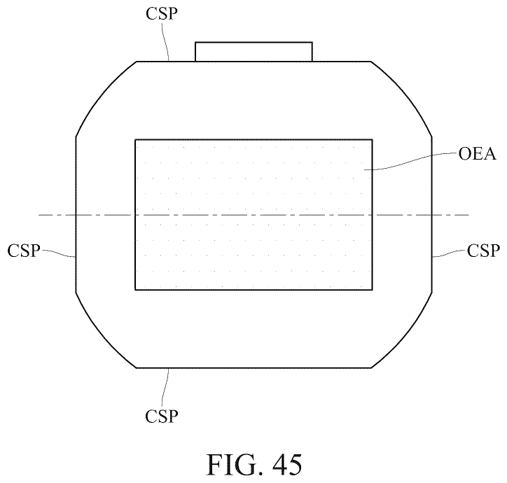

According to the present disclosure, an optically effective area of at least one of the object-side surface and the image-side surface of at least one optical element of the photographing optical lens assembly can be non-circular. Therefore, it is favorable for properly reducing the size of the photographing optical lens assembly in coordination with the shape of the imaging area of the image sensor while providing high image quality. Please refer to FIG. 44 and FIG. 45, which respectively show schematic views of a structure of an optically effective area OEA of a single optical element of a photographing optical lens assembly according to different aspects of the present disclosure. In FIG. 44, the shape of the optically effective area OEA is non-circular, and preferably, a ratio of a long axis to a short axis of the optically effective area OEA can range from 1.20 to 1.90. In FIG. 45, the shape of the optically effective area OEA can be substantially rectangular, and preferably, a ratio of a length to a width of the optically effective area OEA can range from 1.20 to 1.90.

According to the present disclosure, at least one optical element of the photographing optical lens assembly can have at least one pair of trimmed edges that are opposite and parallel to each other at a periphery thereof. Therefore, it is favorable for reducing a single-axis length of the optical element to reduce the lens size and contributing to further miniaturization of the photographing optical lens assembly. Please refer to FIG. 44 and FIG. 45, where FIG. 44 shows a schematic view of a structure of one pair of trimmed edges CSP of a single optical element of a photographing optical lens assembly according to one aspect of the present disclosure, and FIG. 45 shows a schematic view of a structure of two pairs of trimmed edges CSP of a single optical element of a photographing optical lens assembly according to another aspect of the present disclosure. Moreover, the at least one pair of trimmed edges can also serve as a positioning structure during the manufacturing and assembly of the optical element. Additionally, an outer diameter of a barrel, which holds the photographing optical lens assembly, can also be trimmed to form at least one pair of trimmed edges that are opposite and parallel to each other to reduce the lens size.

According to the present disclosure, the aforementioned features and conditions can be utilized in numerous combinations so as to achieve corresponding effects.

According to the present disclosure, the optical elements of the photographing optical lens assembly can be made of either glass or plastic material. When the optical elements are made of glass material, the refractive power distribution of the photographing optical lens assembly may be more flexible, and the influence on imaging caused by external environment temperature change may be reduced. The glass optical element can either be made by grinding or molding. When the optical elements are made of plastic material, the manufacturing costs can be effectively reduced. Furthermore, surfaces of each optical element can be arranged to be spherical or aspheric. Spherical optical elements are simple in manufacture. Aspheric optical element design allows more control variables for eliminating aberrations thereof and reducing the required number of optical elements, and the total track length of the photographing optical lens assembly can therefore be effectively shortened. Additionally, the aspheric surfaces may be formed by plastic injection molding or glass molding.

According to the present disclosure, when a surface of an optical element is aspheric, it means that the surface of the optical element has an aspheric shape throughout its optically effective area, or a portion(s) thereof.

According to the present disclosure, one or more of the optical elements' material may optionally include an additive which generates light absorption and interference effects and alters the optical elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material optical element by injection molding. Moreover, the additive may be coated on the surfaces of the optical elements to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the optical element has a convex surface, it indicates that the surface is convex in the paraxial region thereof; when the optical element has a concave surface, it indicates that the surface is concave in the paraxial region thereof. Moreover, when a region of curvature radius, refractive power or focus of an optical element is not defined, it indicates that the region of curvature radius, refractive power or focus of the optical element is in the paraxial region thereof.

According to the present disclosure, an inflection point is a point on the surface of the optical element at which the surface changes from concave to convex, or vice versa.

According to the present disclosure, the image surface of the photographing optical lens assembly, based on the corresponding image sensor, can be flat or curved, especially a curved surface being concave facing towards the object side of the photographing optical lens assembly.

According to the present disclosure, an image correction unit, such as a field flattener, can be optionally disposed between the optical element closest to the image side of the photographing optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, at least one reflective element with optical path folding function, such as a prism or a mirror, can be optionally provided between an imaged object and the image surface on the imaging optical path, and the surface shape of the prism or mirror can be planar, spherical, aspheric or freeform surface, such that the photographing optical lens assembly can be more flexible in space arrangement, and therefore the dimensions of an electronic device is not restricted by the total track length of the photographing optical lens assembly.

The reflective element can be disposed between an imaged object and the image surface, especially between the last optical element (e.g., the sixth optical element) and the image surface of the photographing optical lens assembly, so as to reduce the size of the photographing optical lens assembly. The optical path can be deflected one time, two times, three times or more by one reflective element. In addition, the reflective element can have at least one reflective surface, and an angle between the optical axis and a normal direction of the reflective surface is not limited to 45 degrees, but can be other angles depending on the space arrangement. The optical path along an optical axis at the object side can be redirected to an optical axis at the image side by the reflective element. An angle between a vector of the optical axis at the object side and that at the image side can be any angle, not limited to 0, 90 or 180 degrees. In addition, in order to reduce the size of the photographing optical lens assembly, the length and the width of the reflective mirror may be different from each other, and the length, the width and the height of the prism may be different from one another. The surface of the reflective element (e.g., the surface of the prism or the reflective mirror) can be planar, spherical, aspheric or have a freeform shape according to the optical design requirements, but the present disclosure is not limited thereto. The reflective element can consist of more than one prism depending on the design requirements. The prism can be made of glass material or plastic material depending on the design requirements.

According to the present disclosure, the photographing optical lens assembly can include at least one stop, such as an aperture stop, a glare stop or a field stop. Said aperture stop, glare stop or said field stop is set for eliminating the stray light and thereby improving image quality thereof.

According to the present disclosure, an aperture stop can be configured as a front stop or a middle stop. A front stop disposed between an imaged object and the first optical element can provide a longer distance between an exit pupil of the photographing optical lens assembly and the image surface to produce a telecentric effect, and thereby improves the image-sensing efficiency of an image sensor (for example, CCD or CMOS). A middle stop disposed between the first optical element and the image surface is favorable for enlarging the viewing angle of the photographing optical lens assembly and thereby provides a wider field of view for the same.

According to the present disclosure, the photographing optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical lens assembly can include one or more optical components for limiting the form of light passing through the photographing optical lens assembly. Each optical component can be, but not limited to, a filter, a polarizer, etc., and each optical component can be, but not limited to, a single-piece component, a composite component, a thin film, etc. The optical component can be located at the object side or the image side of the photographing optical lens assembly or between any two adjacent optical elements so as to allow light in a specific form to pass through, thereby meeting application requirements.

According to the present disclosure, the photographing optical lens assembly can include at least one optical lens element, an optical component, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical component can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

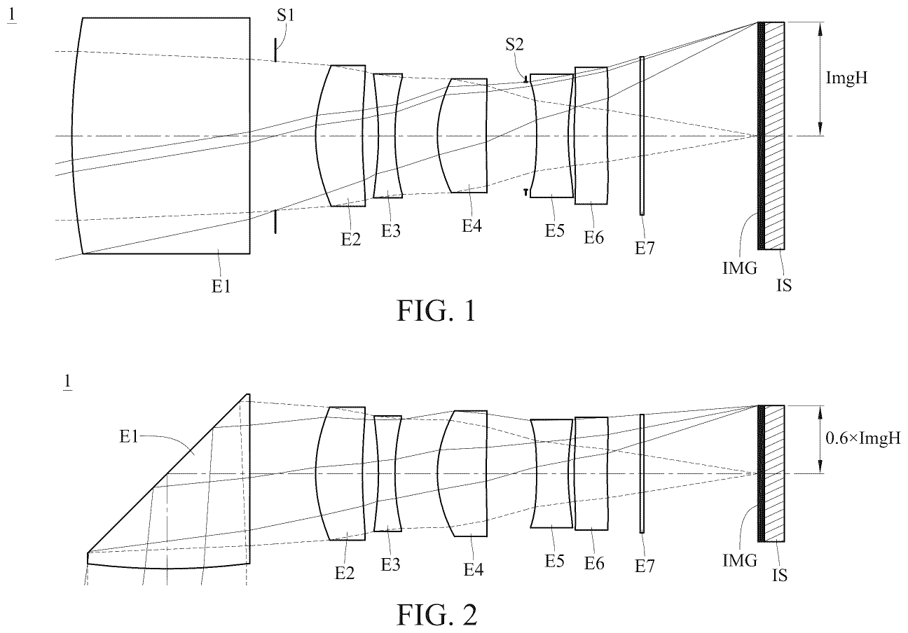

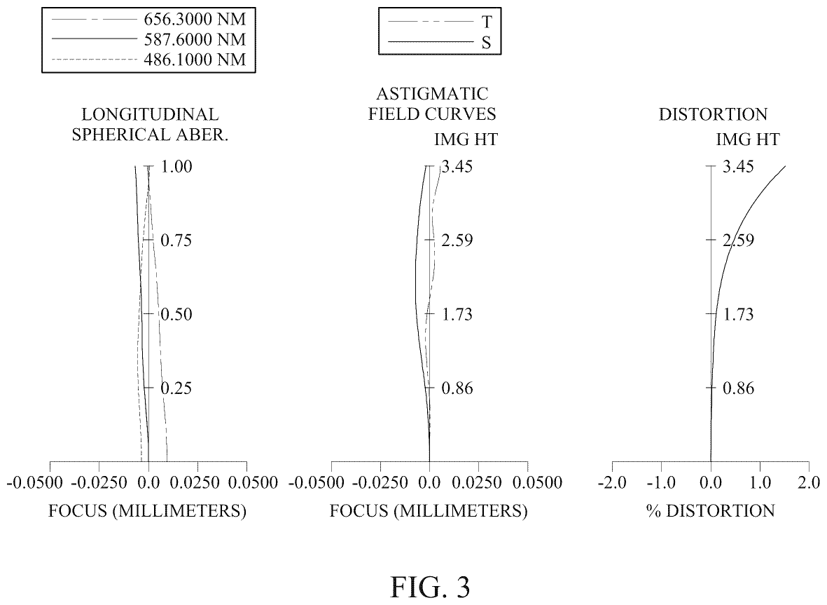

FIG. 1 is a cross-sectional schematic view of an image capturing unit according to the 1st embodiment of the present disclosure, corresponding to a diagonal direction of an effective photosensitive area of an image sensor. FIG. 2 is a cross-sectional schematic view of the image capturing unit according to the 1st embodiment of the present disclosure, corresponding to a short side direction of the effective photosensitive area of the image sensor, with an optical path folded by a first optical element. FIG. 3 shows, in order from left to right, spherical aberration curves, astigmatic field curves and a distortion curve of the image capturing unit according to the 1st embodiment. In FIG. 1 and FIG. 2, the image capturing unit 1 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 1 does not depict the optical path folding effect caused by the first optical element E1. The optical path folding effect of the first optical element E1 is shown in FIG. 2. The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The image-side surface of the first optical element E1 has one inflection point. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is made of plastic material and has the object-side surface and the image-side surface being both aspheric.

The fourth optical element E4 with positive refractive power has an object-side surface being convex in a paraxial region thereof and an image-side surface being concave in a paraxial region thereof. The fourth optical element E4 is made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being concave in a paraxial region thereof. The fifth optical element E5 is made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is made of plastic material and has the object-side surface and the image-side surface being both aspheric. The object-side surface of the sixth optical element E6 has one inflection point. The image-side surface of the sixth optical element E6 has two inflection points.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The equation of the aspheric surface profiles of the aforementioned optical elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8 and 10.

In the photographing optical lens assembly of the image capturing unit 1 according to the 1st embodiment, when a focal length of the photographing optical lens assembly is f, an entrance pupil diameter of the photographing optical lens assembly corresponding to a maximum entrance pupil diameter direction of the aperture stop is EPDmax, and half of a maximum field of view of the photographing optical lens assembly is HFOV, these parameters have the following values: f=15.03 millimeters (mm), f/EPDmax=2.93, and HFOV=12.7 degrees (deg.).

When the maximum field of view of the photographing optical lens assembly is FOV, the following condition is satisfied: FOV=25.4 degrees.

When the focal length of the photographing optical lens assembly is f, and a focal length of the first optical element E1 is f1, the following condition is satisfied: f/f1=0.40.

When the focal length of the photographing optical lens assembly is f, and a focal length of the fourth optical element E4 is f4, the following condition is satisfied: f4/f=0.44.

When the focal length of the photographing optical lens assembly is f, and a composite focal length of the second optical element E2 and the third optical element E3 is f23, the following condition is satisfied: f/f23=−0.65.

When the focal length of the photographing optical lens assembly is f, and a composite focal length of the fifth optical element E5 and the sixth optical element E6 is f56, the following condition is satisfied: f/f56=−1.39.

When the focal length of the photographing optical lens assembly is f, a focal length of the fifth optical element E5 is f5, and a focal length of the sixth optical element E6 is f6, the following condition is satisfied: f/f5+f/f6=−1.35.

When a curvature radius of the image-side surface of the fifth optical element E5 is R10, and the focal length of the sixth optical element E6 is f6, the following condition is satisfied: R10/f6=0.13.

When a curvature radius of the object-side surface of the first optical element E1 is R1, and a curvature radius of the object-side surface of the fourth optical element E4 is R7, the following condition is satisfied: |R7/R1|=0.18.

When a curvature radius of the image-side surface of the first optical element E1 is R2, and a curvature radius of the object-side surface of the second optical element E2 is R3, the following condition is satisfied: |R3/R2|=0.02.

When the curvature radius of the image-side surface of the first optical element E1 is R2, and the curvature radius of the object-side surface of the fourth optical element E4 is R7, the following condition is satisfied: |R7/R2|=0.02.

When the curvature radius of the object-side surface of the fourth optical element E4 is R7, and a curvature radius of the image-side surface of the sixth optical element E6 is R12, the following condition is satisfied: R12/R7=4.00.

When the curvature radius of the image-side surface of the first optical element E1 is R2, the curvature radius of the object-side surface of the fourth optical element E4 is R7, and a curvature radius of the object-side surface of the fifth optical element E5 is R9, the following condition is satisfied: (|R7|+|R9|)/|R2|=0.08.

When the curvature radius of the object-side surface of the second optical element E2 is R3, and the curvature radius of the image-side surface of the sixth optical element E6 is R12, the following condition is satisfied: (R3+R12)/(R3−R12)=−2.07.

When the curvature radius of the object-side surface of the fourth optical element E4 is R7, and the curvature radius of the object-side surface of the fifth optical element E5 is R9, the following condition is satisfied: (R7+R9)/(R7−R9)=−0.60.

When a sum of axial distances between each of all adjacent optical elements of the photographing optical lens assembly is ΣAT, an axial distance between the image-side surface of the sixth optical element E6 and the image surface IMG is BL, and a sum of central thicknesses of all optical elements of the photographing optical lens assembly is ΣCT, the following condition is satisfied: (Σ+BL)/ΣCT=0.93. In this embodiment, an axial distance between two adjacent optical elements is a distance in a paraxial region between two adjacent surfaces of the two adjacent optical elements. In addition, in this embodiment, ΣAT is equal to a sum of an axial distance between the first optical element E1 and the second optical element E2, an axial distance between the second optical element E2 and the third optical element E3, an axial distance between the third optical element E3 and the fourth optical element E4, an axial distance between the fourth optical element E4 and the fifth optical element E5, and an axial distance between the fifth optical element E5 and the sixth optical element E6. Moreover, in this embodiment, ΣCT is equal to a sum of a central thickness of the first optical element E1, a central thickness of the second optical element E2, a central thickness of the third optical element E3, a central thickness of the fourth optical element E4, a central thickness of the fifth optical element E5, and a central thickness of the sixth optical element E6.

When the central thickness of the first optical element E1 is CT1, the central thickness of the second optical element E2 is CT2, the central thickness of the third optical element E3 is CT3, the central thickness of the fourth optical element E4 is CT4, the central thickness of the fifth optical element E5 is CT5, and the central thickness of the sixth optical element E6 is CT6, the following condition is satisfied: (CT2+CT3+CT4+CT5+CT6)/CT1=0.99.

When the central thickness of the third optical element E3 is CT3, and the focal length of the photographing optical lens assembly is f, the following condition is satisfied: 10×CT3/f=0.33.

When the central thickness of the first optical element E1 is CT1, and the central thickness of the third optical element E3 is CT3, the following condition is satisfied: 10×CT3/CT1=0.93.

When the axial distance between the second optical element E2 and the third optical element E3 is T23, and the central thickness of the second optical element E2 is CT2, the following condition is satisfied: T23/CT2=0.34.

When an Abbe number of the fifth optical element E5 is V5, and an Abbe number of the sixth optical element E6 is V6, the following condition is satisfied: V5/V6=3.46.

When a refractive index of the first optical element E1 is N1, the following condition is satisfied: N1=1.544.

When a refractive index of the second optical element E2 is N2, the following condition is satisfied: N2=1.544.

When a refractive index of the fourth optical element E4 is N4, the following condition is satisfied: N4=1.562.

When a maximum effective radius of the object-side surface of the first optical element E1 is Y1R1, and a maximum image height of the photographing optical lens assembly is ImgH, the following condition is satisfied: Y1R1/ImgH=1.04.

When a displacement in parallel with the optical axis from an axial vertex of the object-side surface of the first optical element E1 to a maximum effective radius position of the object-side surface of the first optical element E1 is SAG1R1, a displacement in parallel with the optical axis from an axial vertex of the image-side surface of the first optical element E1 to a maximum effective radius position of the image-side surface of the first optical element E1 is SAG1R2, and a distance in parallel with the optical axis between the maximum effective radius position of the object-side surface of the first optical element E1 and the maximum effective radius position of the image-side surface of the first optical element E1 is ET1, the following condition is satisfied: (SAG1R1+SAG1R2)/ET1=0.06. In this embodiment, the direction of SAG1R1 points toward the image side of the photographing optical lens assembly, and the value of SAG1R1 is positive; the direction of SAG1R2 points toward the object side of the photographing optical lens assembly, and the value of SAG1R2 is negative.

When a displacement in parallel with the optical axis from an axial vertex of the object-side surface of the fifth optical element E5 to a maximum effective radius position of the object-side surface of the fifth optical element E5 is SAG5R1, a displacement in parallel with the optical axis from an axial vertex of the image-side surface of the fifth optical element E5 to a maximum effective radius position of the image-side surface of the fifth optical element E5 is SAG5R2, and the central thickness of the fifth optical element E5 is CT5, the following condition is satisfied: (SAG5R1+SAG5R2)/CT5=−0.04. In this embodiment, the direction of SAG5R1 points toward the object side of the photographing optical lens assembly, and the value of SAG5R1 is negative; the direction of SAG5R2 points toward the image side of the photographing optical lens assembly, and the value of SAG5R2 is positive.

When a displacement in parallel with the optical axis from an axial vertex of the image-side surface of the sixth optical element E6 to a maximum effective radius position of the image-side surface of the sixth optical element E6 is SAG6R2, and the central thickness of the sixth optical element E6 is CT6, the following condition is satisfied: SAG6R2/CT6=−0.0037. In this embodiment, the direction of SAG6R2 points toward the object side of the photographing optical lens assembly, and the value of SAG6R2 is negative.

When an axial distance between the reflective surface of the first optical element E1 and the image surface IMG is P1TL, and an axial distance between the object-side surface of the first optical element E1 and the image surface IMG is TL, the following condition is satisfied: P1TL/TL=0.86.

The detailed optical data of the 1st embodiment are shown in Table 1A and the aspheric surface data are shown in Table 1B below.

TABLE 1A
1st Embodiment
f = 15.03 mm, f/EPDmax = 2.93, HFOV = 12.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 18.7518 | (ASP) | 5.399 | Plastic | 1.544 | 55.9 | 37.47 |
| 2 | | 212.7660 | (ASP) | 0.779 | | | | |
| 3 | Stop | Plano | | 1.221 | | | | |
| 4 | Optic 2 | 4.6861 | (ASP) | 1.421 | Plastic | 1.544 | 55.9 | 11.46 |
| 5 | | 16.8864 | (ASP) | 0.487 | | | | |
| 6 | Optic 3 | −8.4049 | (ASP) | 0.500 | Plastic | 1.615 | 25.4 | −6.41 |
| 7 | | 7.5789 | (ASP) | 1.287 | | | | |
| 8 | Optic 4 | 3.3682 | (ASP) | 1.486 | Plastic | 1.562 | 44.6 | 6.59 |
| 9 | | 31.4080 | (ASP) | 1.199 | | | | |
| 10 | Stop | Plano | | 0.330 | | | | |
| 11 | Optic 5 | −13.3860 | (ASP) | 0.958 | Plastic | 1.515 | 56.4 | −9.31 |
| 12 | | 7.6616 | (ASP) | 0.180 | | | | |
| 13 | Optic 6 | 10.3932 | (ASP) | 1.004 | Plastic | 1.697 | 16.3 | 57.44 |
| 14 | | 13.4785 | (ASP) | 1.000 | | | | |

| | | | | | | | |
|---|---|---|---|---|---|---|---|
| 15 | Filter | Plano | 0.110 | Glass | 1.517 | 64.2 | — |
| 16 | | Plano | 3.467 | | | | |
| 17 | Image | Plano | — | | | | |

Note:
Reference wavelength is 587.6 nm (d-line).
An effective radius of the stop S1 (Surface 3) is 2.268 mm.
An effective radius of the stop S2 (Surface 10) is 1.635 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 1B
Aspheric Coefficients

| Surface # | 1 | 2 | 4 | 5 | 6 | 7 |
|---|---|---|---|---|---|---|
| k= | −5.16536E+00 | −9.00000E+01 | −1.89802E+00 | −8.59265E+00 | −3.07327E+01 | 6.00552E+00 |
| A4= | −3.034E−05 | −4.007E−04 | 1.457E−03 | 3.625E−04 | 1.700E−03 | −5.886E−04 |
| A6= | — | — | −2.060E−04 | −7.026E−04 | −3.488E−04 | −3.832E−04 |
| A8= | — | — | −2.358E−06 | 5.305E−05 | 8.923E−05 | 1.068E−04 |
| A10= | — | — | −2.923E−06 | −7.418E−06 | −1.320E−05 | −1.971E−05 |
| Surface # | 8 | 9 | 11 | 12 | 13 | 14 |
| k= | −4.28423E−01 | 6.68363E+01 | −6.43943E+00 | 4.71713E+00 | −1.20997E+01 | 2.36964E+01 |
| A4= | −5.076E−03 | −3.148E−03 | −5.100E−03 | −1.697E−03 | −1.637E−02 | −1.775E−02 |
| A6= | 4.451E−04 | −4.206E−04 | −4.859E−03 | −4.188E−03 | 1.454E−03 | 2.242E−03 |
| A8= | −3.866E−05 | 1.038E−04 | 8.706E−04 | 9.878E−04 | 1.666E−04 | −1.648E−04 |
| A10= | 9.950E−06 | 6.090E−06 | −5.079E−05 | −8.781E−05 | −2.650E−05 | 6.062E−06 |

In Table 1A, the curvature radius, the thickness and the focal length are shown in millimeters (mm). Surface numbers 0-17 represent the surfaces sequentially arranged from the object side to the image side along the optical axis. In Table 1B, k represents the conic coefficient of the equation of the aspheric surface profiles. A4-A10 represent the aspheric coefficients ranging from the 4th order to the 10th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

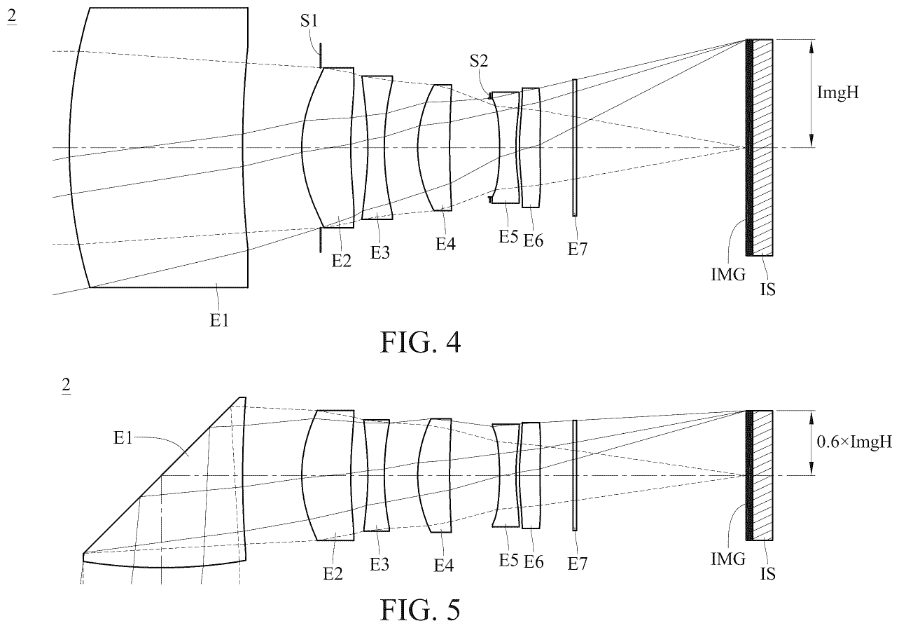

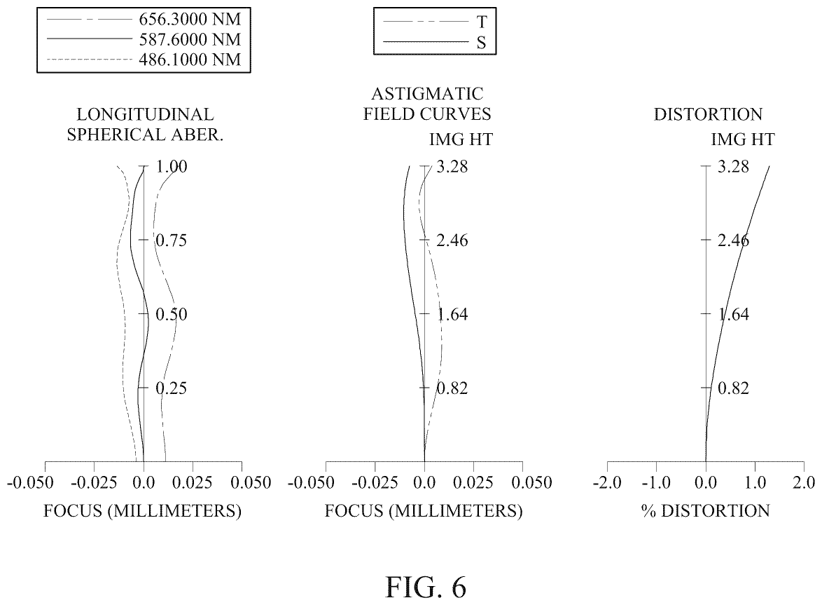

FIG. 4 is a cross-sectional schematic view of an image capturing unit according to the 2nd embodiment of the present disclosure, corresponding to a diagonal direction of an effective photosensitive area of an image sensor. FIG. 5 is a cross-sectional schematic view of the image capturing unit according to the 2nd embodiment of the present disclosure, corresponding to a short side direction of the effective photosensitive area of the image sensor, with an optical path folded by a first optical element. FIG. 6 shows, in order from left to right, spherical aberration curves, astigmatic field curves and a distortion curve of the image capturing unit according to the 2nd embodiment. In FIG. 4 and FIG. 5, the image capturing unit 2 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 4 does not depict the optical path folding effect caused by the first optical element E1. The optical path folding effect of the first optical element E1 is shown in FIG. 5. The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric. The image-side surface of the fourth optical element E4 has two inflection points.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has one inflection point. The image-side surface of the sixth optical element E6 has one inflection point.

The filter E7 is made of glass material and located between the sixth optical element E6 and the image surface IMG, and will not affect the focal length of the photographing optical lens assembly. The image sensor IS is disposed on or neer the image surface IMG of the photographing optical lens assembly.

The detailed optical data of the 2nd embodiment are shown in Table 2A and the aspheric surface data are shown in Table 2B below.

TABLE 2A
2nd Embodiment
f = 16.42 mm, f/EPDmax = 2.80, HFOV = 11.1 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 15.2016 | (ASP) | 5.266 | Plastic | 1.545 | 56.1 | 49.98 |
| 2 | | 30.1997 | (ASP) | 2.368 | | | | |
| 3 | Stop | Plano | | −0.572 | | | | |
| 4 | Optic 2 | 4.0877 | (ASP) | 1.489 | Plastic | 1.545 | 56.1 | 10.23 |
| 5 | | 13.3553 | (ASP) | 0.519 | | | | |
| 6 | Optic 3 | −8.1956 | (ASP) | 0.500 | Plastic | 1.615 | 25.3 | −6.72 |
| 7 | | 8.5368 | (ASP) | 1.014 | | | | |
| 8 | Optic 4 | 3.5416 | (ASP) | 0.972 | Plastic | 1.545 | 56.1 | 7.60 |
| 9 | | 22.1361 | (ASP) | 1.224 | | | | |
| 10 | Stop | Plano | | 0.292 | | | | |
| 11 | Optic 5 | −9.3342 | (ASP) | 0.500 | Plastic | 1.545 | 56.1 | −7.96 |
| 12 | | 8.2543 | (ASP) | 0.103 | | | | |
| 13 | Optic 6 | 7.3217 | (ASP) | 0.625 | Plastic | 1.669 | 19.5 | 18.76 |
| 14 | | 16.9728 | (ASP) | 1.000 | | | | |

| | | | | | | | |
|---|---|---|---|---|---|---|---|
| 15 | Filter | Plano | 0.110 | Glass | 1.517 | 64.2 | — |
| 16 | | Plano | 5.157 | | | | |
| 17 | Image | Plano | — | | | | |

Note:
Reference wavelength is 587.6 nm (d-line).
An effective radius of the stop S1 (Surface 3) is 2.432 mm.
An effective radius of the stop S2 (Surface 10) is 1.500 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 2B
Aspheric Coefficients

| Surface # | 1 | 2 | 4 | 5 | 6 | 7 |
|---|---|---|---|---|---|---|
| k= | 3.05903E−01 | 1.67580E+01 | −1.69795E+00 | −2.25039E+01 | −4.42376E+01 | 6.37599E+00 |
| A4= | 4.245E−05 | −6.297E−05 | 1.941E−03 | 1.910E−03 | 1.311E−03 | −1.322E−03 |
| A6= | — | — | −2.639E−04 | −1.630E−03 | −5.743E−04 | 8.371E−05 |
| A8= | — | — | 3.759E−07 | 1.861E−04 | 1.496E−04 | 1.573E−05 |
| A10= | — | — | −3.449E−06 | −1.197E−05 | −1.515E−05 | −1.040E−05 |
| Surface # | 8 | 9 | 11 | 12 | 13 | 14 |
| k= | −3.43675E−01 | 7.56832E+01 | 1.95246E+01 | −2.28435E+00 | −7.80021E+00 | 4.95330E+01 |
| A4= | −8.505E−03 | −4.466E−03 | −2.575E−03 | 1.273E−02 | −7.512E−03 | −1.934E−02 |
| A6= | 2.318E−03 | 1.055E−03 | −7.973E−03 | −1.705E−02 | −6.769E−03 | 7.129E−04 |
| A8= | −3.995E−04 | −3.153E−04 | 1.087E−03 | 4.666E−03 | 2.985E−03 | 5.464E−04 |
| A10= | 4.220E−05 | 3.327E−05 | −4.649E−05 | −5.144E−04 | −3.883E−04 | −8.628E−05 |

In the 2nd embodiment, the equation of the aspheric surface profiles of the aforementioned optical elements is the same as the equation of the 1st embodiment. Also, the definitions of these parameters shown in Table 2C below are the same as those stated in the 1st embodiment, with corresponding values for the 2nd embodiment; therefore, an explanation in this regard will not be provided again. Moreover, these parameters can be calculated from Table 2A and Table 2B as the following values and satisfy the following conditions:

TABLE 2C
Values of Optical and Physical Parameters/Definitions

| | | | |
|---|---|---|---|
| f [mm] | 16.42 | (R7 + R9)/(R7 − R9) | −0.45 |
| f/EPDmax | 2.80 | (ΣAT + BL)/ΣCT | 1.20 |
| HFOV [deg.] | 11.1 | (CT2 + CT3 + CT4 + | 0.78 |
| | | CT5 + CT6)/CT1 | |
| FOV [deg.] | 22.2 | 10 × CT3/f | 0.30 |
| f/f1 | 0.33 | 10 × CT3/CT1 | 0.95 |
| f4/f | 0.46 | T23/CT2 | 0.35 |
| f/f23 | −0.36 | V5/V6 | 2.88 |
| f/f56 | −1.19 | N1 | 1.545 |
| f/f5 + f/f6 | −1.19 | N2 | 1.545 |
| R10/f6 | 0.44 | N4 | 1.545 |
| \|R7/R1\| | 0.23 | Y1R1/ImgH | 1.29 |
| \|R3/R2\| | 0.14 | (SAG1R1 + SAG1R2)/ET1 | 0.16 |
| \|R7/R2\| | 0.12 | (SAG5R1 + SAG5R2)/CT5 | −0.27 |
| R12/R7 | 4.79 | SAG6R2/CT6 | −0.06 |
| (\|R7\| + \|R9\|)/\|R2\| | 0.43 | P1TL/TL | 0.86 |
| (R3 + R12)/(R3 − R12) | −1.63 | — | — |

### 3rd Embodiment

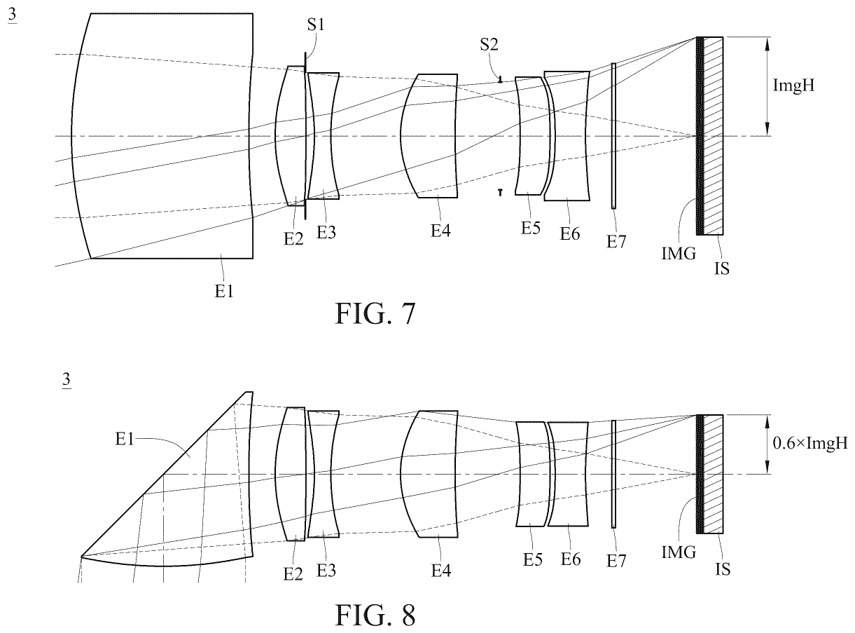

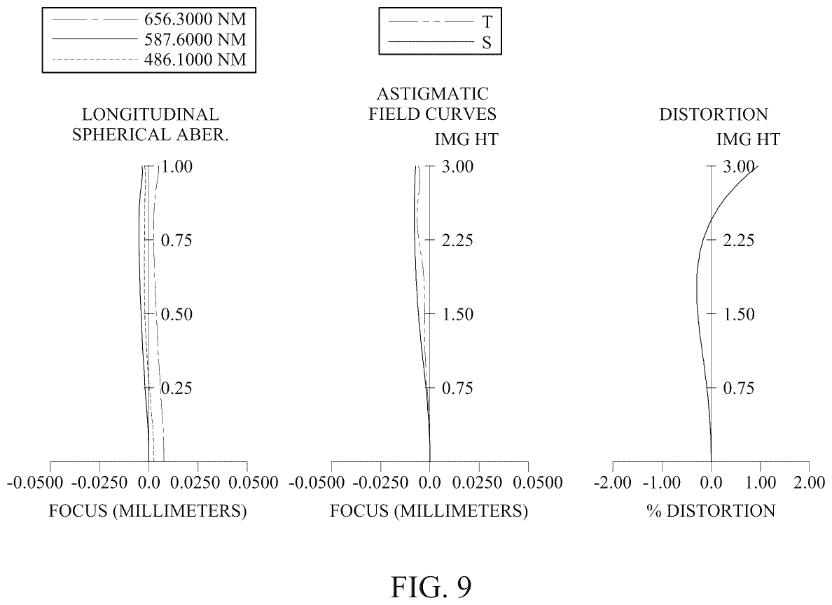

FIG. 7 is a cross-sectional schematic view of an image capturing unit according to the 3rd embodiment of the present disclosure, corresponding to a diagonal direction of an effective photosensitive area of an image sensor. FIG. 8 is a cross-sectional schematic view of the image capturing unit according to the 3rd embodiment of the present disclosure, corresponding to a short side direction of the effective photosensitive area of the image sensor, with an optical path folded by a first optical element. FIG. 9 shows, in order from left to right, spherical aberration curves, astigmatic field curves and a distortion curve of the image capturing unit according to the 3rd embodiment. In FIG. 7 and FIG. 8, the image capturing unit 3 includes the photographing optical lens assembly (its reference numeral is omitted) of the present disclosure and an image sensor IS. The photographing optical lens assembly includes, in order from an object side to an image side along an optical path, a first optical element E1, a second optical element E2, a stop S1, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 7 does not depict the optical path folding effect caused by the first optical element E1. The optical path folding effect of the first optical element E1 is shown in FIG. 8.

The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The first optical element E1 with an optical path folding function has a reflective surface.

The second optical element E2 with positive refractive power has an object-side surface being convex in a paraxial region thereof and an image-side surface being convex in a paraxial region thereof. The second optical element E2 is a lens element made of plastic material and has the object-side surface and the image-side surface being both aspheric. The object-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric.

The fifth optical element E5 with positive refractive power has an object-side surface being concave in a paraxial region thereof and an image-side surface being convex in a paraxial region thereof. The fifth optical element E5 is a lens element made of plastic material and has the object-side surface and the image-side surface being both aspheric.

The sixth optical element E6 with negative refractive power has an object-side surface being concave in a paraxial region thereof and an image-side surface being concave in a paraxial region thereof. The sixth optical element E6 is a lens element made of plastic material and has the object-side surface and the image-side surface being both aspheric.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 3rd embodiment are shown in Table 3A and the aspheric surface data are shown in Table 3B below.

TABLE 3A
3rd Embodiment
f = 13.41 mm, f/EPDmax = 2.70, HFOV = 12.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 11.5469 | (ASP) | 5.389 | Plastic | 1.544 | 56.0 | 30.85 |
| 2 | | 30.9276 | (ASP) | 0.800 | | | | |
| 3 | Optic 2 | 5.4386 | (ASP) | 0.933 | Plastic | 1.544 | 56.0 | 9.18 |
| 4 | | −57.6754 | (ASP) | −0.014 | | | | |
| 5 | Stop | Plano | | 0.272 | | | | |
| 6 | Optic 3 | −6.1369 | (ASP) | 0.500 | Plastic | 1.584 | 28.2 | −5.55 |
| 7 | | 7.0696 | (ASP) | 2.115 | | | | |
| 8 | Optic 4 | 3.1623 | (ASP) | 1.660 | Plastic | 1.551 | 44.8 | 6.54 |
| 9 | | 21.0558 | (ASP) | 1.370 | | | | |
| 10 | Stop | Plano | | 0.605 | | | | |
| 11 | Optic 5 | −18.5435 | (ASP) | 0.909 | Plastic | 1.511 | 56.8 | 236.07 |
| 12 | | −16.3387 | (ASP) | 0.155 | | | | |
| 13 | Optic 6 | −12.2022 | (ASP) | 0.921 | Plastic | 1.551 | 44.8 | −9.61 |
| 14 | | 9.6026 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 2.469 | | | | |
| 17 | Image | Plano | — | | | | |

Note:
Reference wavelength is 587.6 nm (d-line).
An effective radius of the stop S1 (Surface 5) is 1.938 mm.
An effective radius of the stop S2 (Surface 10) is 1.635 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 3B
Aspheric Coefficients

| Surface # | 1 | 2 | 3 | 4 | 6 | 7 |
|---|---|---|---|---|---|---|
| k= | 1.64669E−01 | −2.90988E+01 | −2.41067E+00 | −9.00000E+01 | −1.88267E+01 | 6.80940E+00 |
| A4= | −1.564E−04 | 5.945E−04 | 2.221E−03 | 4.164E−03 | 2.189E−03 | −2.740E−03 |
| A6= | — | — | −3.716E−04 | −2.014E−03 | −5.733E−05 | 7.866E−04 |
| A8= | — | — | −3.593E−05 | 2.642E−04 | 1.713E−05 | −1.686E−04 |
| A10= | — | — | −2.402E−07 | −2.061E−05 | −8.651E−06 | −1.026E−05 |

| Surface # | 8 | 9 | 11 | 12 | 13 | 14 |
|---|---|---|---|---|---|---|
| k= | −3.99992E−01 | 6.59197E+01 | −3.09764E+01 | 5.47801E+01 | 3.00747E+01 | 1.08656E+01 |
| A4= | −5.859E−03 | −3.571E−03 | −6.317E−03 | −1.811E−03 | −1.515E−02 | −1.747E−02 |
| A6= | 6.187E−04 | 4.238E−04 | −2.639E−03 | −8.788E−03 | −2.630E−03 | 3.652E−03 |
| A8= | −7.405E−06 | 8.837E−05 | 8.795E−04 | 1.421E−03 | 5.493E−04 | −2.950E−04 |
| A10= | 3.196E−06 | −1.250E−06 | −1.271E−04 | −4.005E−05 | 5.081E−05 | 8.712E−06 |

In the 3rd embodiment, the equation of the aspheric surface profiles of the aforementioned optical elements is the same as the equation of the 1st embodiment. Also, the definitions of these parameters shown in Table 3C below are the same as those stated in the 1st embodiment, with corresponding values for the 3rd embodiment; therefore, an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f [mm] | 13.41 | (R7 + R9)/(R7 − R9) | −0.71 |
| f/EPDmax | 2.70 | (ΣAT + BL)/ΣCT | 0.84 |
| HFOV [deg.] | 12.5 | (CT2 + CT3 + CT4 + | 0.91 |
| | | CT5 + CT6)/CT1 | |
| FOV [deg.] | 25.0 | 10 × CT3/f | 0.37 |
| f/f1 | 0.43 | 10 × CT3/CT1 | 0.93 |
| f4/f | 0.49 | T23/CT2 | 0.28 |
| f/f23 | −0.71 | V5/V6 | 1.27 |
| f/f56 | −1.36 | N1 | 1.544 |
| f/f5 + f/f6 | −1.34 | N2 | 1.544 |
| R10/f6 | 1.70 | N4 | 1.551 |
| \|R7/R1\| | 0.27 | Y1R1/ImgH | 1.24 |
| \|R3/R2\| | 0.18 | (SAG1R1 + SAG1R2)/ET1 | 0.14 |
| \|R7/R2\| | 0.10 | (SAG5R1 + SAG5R2)/CT5 | −0.48 |
| R12/R7 | 3.04 | SAG6R2/CT6 | 0.14 |
| (\|R7\| + \|R9\|)/\|R2\| | 0.70 | P1TL/TL | 0.85 |
| (R3 + R12)/(R3 − R12) | −3.61 | — | — |

### 4th Embodiment

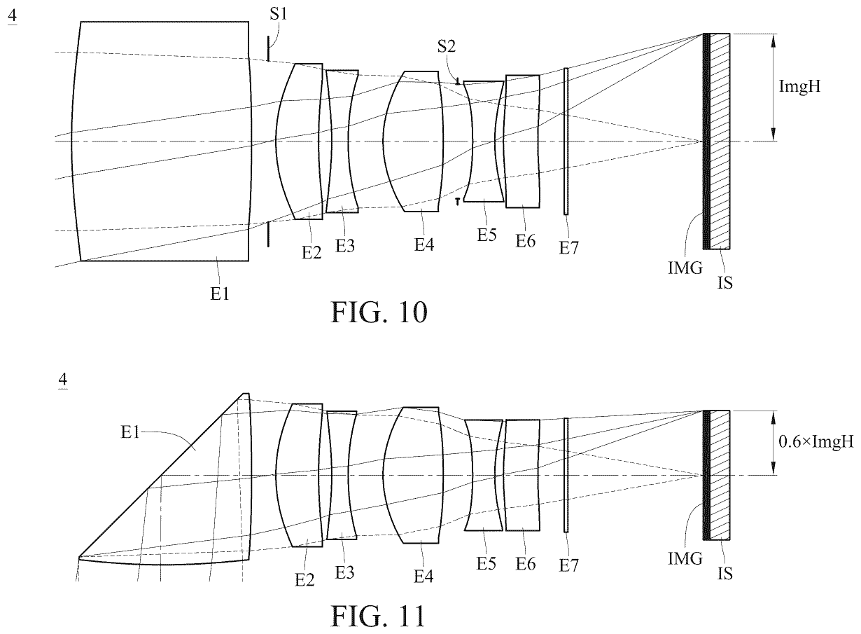

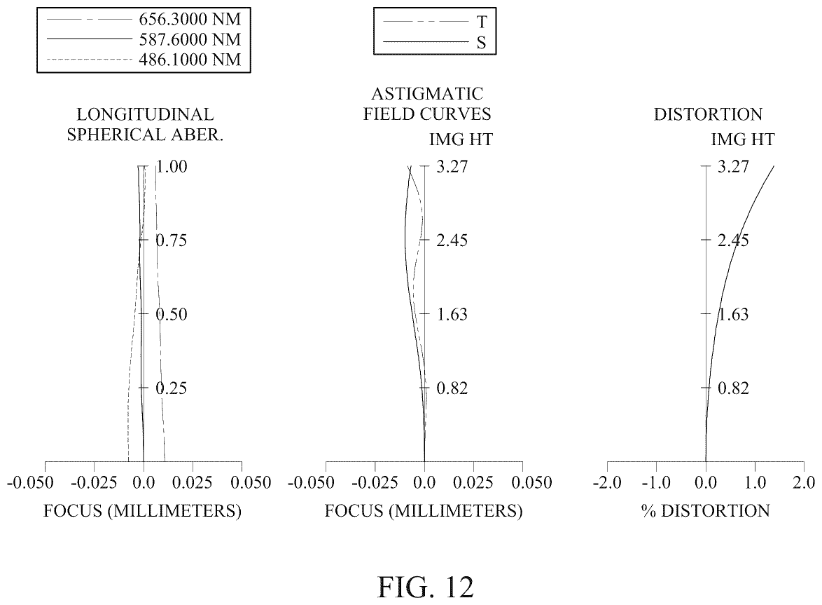

FIG. 10 is a cross-sectional schematic view of an image capturing unit according to the 4th embodiment of the present disclosure, corresponding to a diagonal direction of an effective photosensitive area of an image sensor. FIG. 11 is a cross-sectional schematic view of the image capturing unit according to the 4th embodiment of the present disclosure, corresponding to a short side direction of the effective photosensitive area of the image sensor, with an optical path folded by a first optical element. FIG. 12 shows, in order from left to right, spherical aberration curves, astigmatic field curves and a distortion curve of the image capturing unit according to the 4th embodiment. In FIG. 10 and FIG. 11, the image capturing unit 4 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 10 does not depict the optical path folding effect caused by the first optical element E1. The optical path folding effect of the first optical element E1 is shown in FIG. 11. The first optical element E1 with positive refractive power has an object-side surface being convex in a paraxial region thereof and an image-side surface being convex in a paraxial region thereof. The first optical element E1 is a prism made of plastic material and has the object-side surface and the image-side surface being both aspheric. The object-side surface of the first optical element E1 has one inflection point. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric.

The fourth optical element E4 with positive refractive power has an object-side surface being convex in a paraxial region thereof and an image-side surface being convex in a paraxial region thereof. The fourth optical element E4 is a lens element made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has one inflection point. The image-side surface of the sixth optical element E6 has one inflection point.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly. The detailed optical data of the 4th embodiment are shown in Table 4A and the aspheric surface data are shown in Table 4B below.

TABLE 4A
4th Embodiment
f = 14.26 mm, f/EPDmax = 2.63, HFOV = 12.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 19.2293 | (ASP) | 5.470 | Plastic | 1.515 | 56.4 | 28.43 |
| 2 | | −55.5556 | (ASP) | 0.507 | | | | |
| 3 | Stop | Plano | | 0.231 | | | | |
| 4 | Optic 2 | 4.7143 | (ASP) | 1.299 | Plastic | 1.511 | 56.8 | 13.19 |
| 5 | | 14.2205 | (ASP) | 0.399 | | | | |
| 6 | Optic 3 | −9.2382 | (ASP) | 0.500 | Plastic | 1.614 | 25.6 | −6.55 |
| 7 | | 7.2571 | (ASP) | 1.059 | | | | |
| 8 | Optic 4 | 3.3871 | (ASP) | 1.830 | Plastic | 1.551 | 44.8 | 5.34 |
| 9 | | −17.9637 | (ASP) | 0.437 | | | | |
| 10 | Stop | Plano | | 0.457 | | | | |
| 11 | Optic 5 | −9.1608 | (ASP) | 0.673 | Plastic | 1.529 | 45.4 | −6.01 |
| 12 | | 4.9957 | (ASP) | 0.262 | | | | |
| 13 | Optic 6 | 7.7572 | (ASP) | 1.047 | Plastic | 1.697 | 16.3 | 37.22 |
| 14 | | 10.4519 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 4.118 | | | | |
| 17 | Image | Plano | — | | | | |

Note:
Reference wavelength is 587.6 nm (d-line).
An effective radius of the stop S1 (Surface 3) is 2.450 mm.
An effective radius of the stop S2 (Surface 10) is 1.742 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 4B
Aspheric Coefficients

| Surface # | 1 | 2 | 4 | 5 | 6 | 7 |
|---|---|---|---|---|---|---|
| k= | −1.93644E−01 | 9.00000E+01 | −1.33742E+00 | 1.62193E−01 | −3.05565E+01 | 5.55696E+00 |
| A4= | −3.679E−04 | −5.736E−04 | 1.601E−03 | 6.188E−04 | 1.153E−03 | −2.318E−03 |
| A6= | — | — | −9.365E−05 | −3.559E−04 | 1.221E−04 | 2.895E−04 |
| A8= | — | — | −1.467E−05 | −5.275E−05 | −9.117E−06 | 5.272E−05 |
| A10= | — | — | −3.157E−06 | 3.848E−07 | −4.906E−06 | −1.856E−05 |

| Surface # | 8 | 9 | 11 | 12 | 13 | 14 |
|---|---|---|---|---|---|---|
| k= | −3.74793E−01 | 2.63732E+01 | −5.99117E−02 | 1.58022E+00 | −7.31039E+00 | 1.36097E+01 |
| A4= | −5.429E−03 | −1.942E−03 | −2.932E−03 | −6.119E−03 | −1.921E−02 | −1.742E−02 |
| A6= | 4.302E−04 | −1.217E−03 | −6.963E−03 | −8.923E−04 | 4.965E−03 | 2.622E−03 |
| A8= | 1.182E−05 | 3.842E−04 | 1.822E−03 | 2.077E−04 | −9.192E−04 | −3.883E−04 |
| A10= | 3.488E−06 | −2.408E−05 | −1.739E−04 | −4.256E−05 | 6.350E−05 | 2.744E−05 |

In the 4th embodiment, the equation of the aspheric surface profiles of the aforementioned optical elements is the same as the equation of the 1st embodiment. Also, the definitions of these parameters shown in Table 4C below are the same as those stated in the 1st embodiment, with corresponding values for the 4th embodiment; therefore, an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 14.26 | (R7 + R9)/(R7 − R9) | −0.46 |
| f/EPDmax | 2.63 | (ΣAT + BL)/ΣCT | 0.77 |
| HFOV [deg.] | 12.7 | (CT2 + CT3 + CT4 + | 0.98 |
| | | CT5 + CT6)/CT1 | |
| FOV [deg.] | 25.4 | 10 × CT3/f | 0.35 |
| f/f1 | 0.50 | 10 × CT3/CT1 | 0.91 |
| f4/f | 0.37 | T23/CT2 | 0.31 |
| f/f23 | −0.80 | V5/V6 | 2.79 |
| f/f56 | −2.06 | N1 | 1.515 |
| f/f5 + f/f6 | −1.99 | N2 | 1.511 |
| R10/f6 | 0.13 | N4 | 1.551 |
| \|R7/R1\| | 0.18 | Y1R1/ImgH | 1.11 |
| \|R3/R2\| | 0.08 | (SAG1R1 + SAG1R2)/ET1 | 0.04 |
| \|R7/R2\| | 0.06 | (SAG5R1 + SAG5R2)/CT5 | 0.01 |
| R12/R7 | 3.09 | SAG6R2/CT6 | 0.04 |
| (\|R7\| + \|R9\|)/\|R2\| | 0.23 | P1TL/TL | 0.86 |
| (R3 + R12)/(R3 − R12) | −2.64 | — | — |

### 5th Embodiment

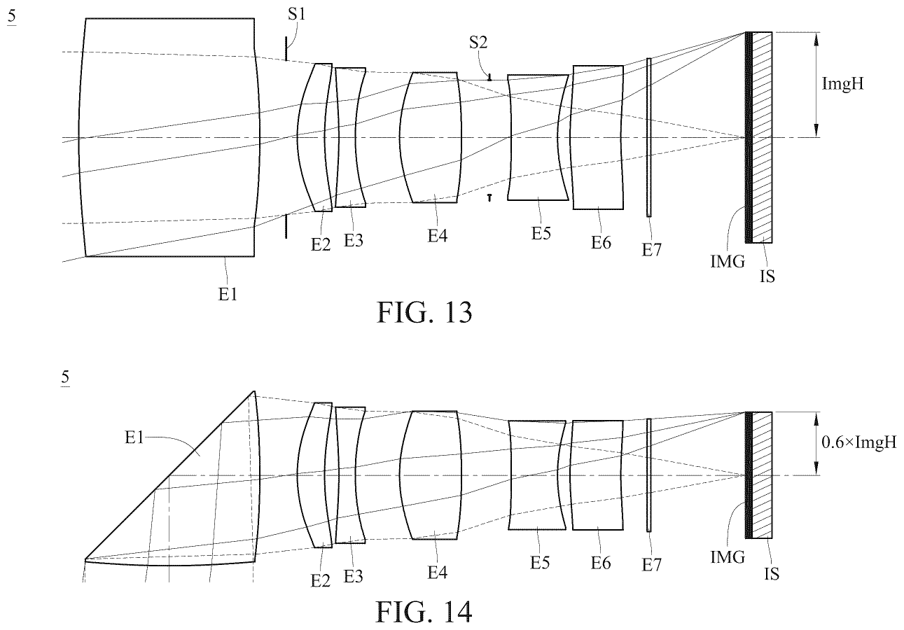

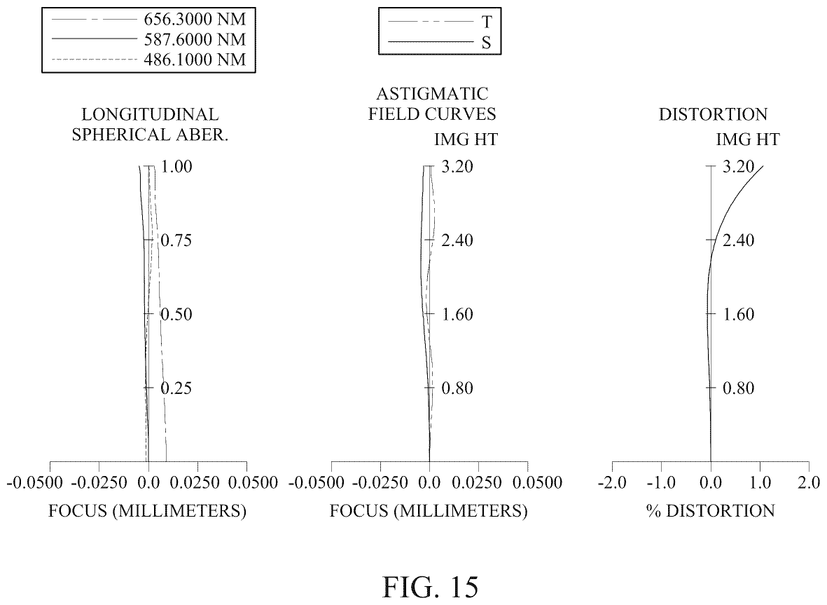

FIG. 13 is a cross-sectional schematic view of an image capturing unit according to the 5th embodiment of the present disclosure, corresponding to a diagonal direction of an effective photosensitive area of an image sensor. FIG. 14 is a cross-sectional schematic view of the image capturing unit according to the 5th embodiment of the present disclosure, corresponding to a short side direction of the effective photosensitive area of the image sensor, with an optical path folded by a first optical element. FIG. 15 shows, in order from left to right, spherical aberration curves, astigmatic field curves and a distortion curve of the image capturing unit according to the 5th embodiment. In FIG. 13 and FIG. 14, the image capturing unit 5 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 13 does not depict the optical path folding effect caused by the first optical element E1. The optical path folding effect of the first optical element E1 is shown in FIG. 14.

The first optical element E1 with positive refractive power has an object-side surface being convex in a paraxial region thereof and an image-side surface being convex in a paraxial region thereof. The first optical element E1 is a prism made of plastic material and has the object-side surface and the image-side surface being both aspheric. The object-side surface of the first optical element E1 has one inflection point. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric. The object-side surface of the third optical element E3 has two inflection points.

The fourth optical element E4 with positive refractive power has an object-side surface being convex in a paraxial region thereof and an image-side surface being convex in a paraxial region thereof. The fourth optical element E4 is a lens element made of plastic material and has the object-side surface and the image-side surface being both aspheric.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has one inflection point. The image-side surface of the sixth optical element E6 has two inflection points.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 5th embodiment are shown in Table 5A and the aspheric surface data are shown in Table 5B below.

TABLE 5A
5th Embodiment
f = 14.17 mm, f/EPDmax = 2.72, HFOV = 12.6 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 25.0080 | (ASP) | 5.500 | Plastic | 1.530 | 55.8 | 24.17 |
| 2 | | −24.2903 | (ASP) | 0.803 | | | | |
| 3 | Stop | Plano | | 0.334 | | | | |
| 4 | Optic 2 | 4.3478 | (ASP) | 0.831 | Plastic | 1.511 | 56.8 | 17.46 |
| 5 | | 7.9329 | (ASP) | 0.433 | | | | |
| 6 | Optic 3 | −13.5753 | (ASP) | 0.500 | Plastic | 1.587 | 28.3 | −7.78 |
| 7 | | 6.9823 | (ASP) | 1.344 | | | | |
| 8 | Optic 4 | 4.3478 | (ASP) | 1.883 | Plastic | 1.544 | 56.0 | 6.66 |
| 9 | | −18.3556 | (ASP) | 0.849 | | | | |
| 10 | Stop | Plano | | 0.663 | | | | |
| 11 | Optic 5 | −34.1884 | (ASP) | 1.405 | Plastic | 1.534 | 56.0 | −7.95 |
| 12 | | 4.9211 | (ASP) | 0.380 | | | | |
| 13 | Optic 6 | 8.8430 | (ASP) | 1.543 | Plastic | 1.642 | 22.5 | 72.24 |
| 14 | | 10.1824 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 2.880 | | | | |
| 17 | Image | Plano | — | | | | |

Note:
Reference wavelength is 587.6 nm (d-line).
An effective radius of the stop S1 (Surface 3) is 2.345 mm.
An effective radius of the stop S2 (Surface 10) is 1.745 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 5B
Aspheric Coefficients

| Surface # | 1 | 2 | 4 | 5 | 6 | 7 |
|---|---|---|---|---|---|---|
| k= | −5.74960E−01 | 2.12778E+01 | −1.78173E+00 | −5.45783E+00 | −4.25869E+01 | 5.39066E+00 |
| A4= | −2.788E−04 | −1.873E−04 | 1.733E−03 | −4.753E−05 | 1.628E−03 | −1.613E−03 |
| A6= | — | — | −1.998E−04 | −3.300E−04 | 1.323E−04 | 2.791E−04 |
| A8= | — | — | −1.765E−05 | −4.936E−06 | −8.296E−06 | −3.160E−05 |
| A10= | — | — | −5.263E−06 | −5.935E−06 | −3.950E−06 | −8.424E−06 |

| Surface # | 8 | 9 | 11 | 12 | 13 | 14 |
|---|---|---|---|---|---|---|
| k= | −5.33291E−01 | 2.13223E+01 | −9.00000E+01 | 1.77319E+00 | 2.27908E+00 | 5.31478E+00 |
| A4= | −4.618E−03 | −2.756E−03 | −1.705E−03 | −1.939E−03 | −1.358E−02 | −1.352E−02 |
| A6= | 1.408E−04 | −4.209E−04 | −2.515E−03 | −1.595E−03 | 1.636E−03 | 1.611E−03 |
| A8= | 2.067E−05 | 1.175E−04 | 3.846E−04 | 1.949E−04 | −6.503E−05 | −1.322E−04 |
| A10= | 8.022E−08 | −5.444E−06 | −2.593E−05 | −2.274E−05 | −3.380E−06 | 8.580E−06 |

In the 5th embodiment, the equation of the aspheric surface profiles of the aforementioned optical elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f [mm] | 14.17 | (R7 + R9)/(R7 − R9) | −0.77 |
| f/EPDmax | 2.72 | (ΣAT + BL)/ΣCT | 0.74 |
| HFOV [deg.] | 12.6 | (CT2 + CT3 + CT4 + | 1.12 |
| | | CT5 + CT6)/CT1 | |
| FOV [deg.] | 25.2 | 10 × CT3/f | 0.35 |
| f/f1 | 0.59 | 10 × CT3/CT1 | 0.91 |
| f4/f | 0.47 | T23/CT2 | 0.52 |
| f/f23 | −0.83 | V5/V6 | 2.49 |
| f/f56 | −1.68 | N1 | 1.530 |
| f/f5 + f/f6 | −1.59 | N2 | 1.511 |
| R10/f6 | 0.07 | N4 | 1.544 |
| \|R7/R1\| | 0.17 | Y1R1/ImgH | 1.13 |
| \|R3/R2\| | 0.18 | (SAG1R1 + SAG1R2)/ET1 | 0.01 |
| \|R7/R2\| | 0.18 | (SAG5R1 + SAG5R2)/CT5 | 0.16 |
| R12/R7 | 2.34 | SAG6R2/CT6 | 0.05 |
| (\|R7\| + \|R9\|)/\|R2\| | 1.59 | P1TL/TL | 0.86 |
| (R3 + R12)/(R3 − R12) | −2.49 | — | — |

### 6th Embodiment

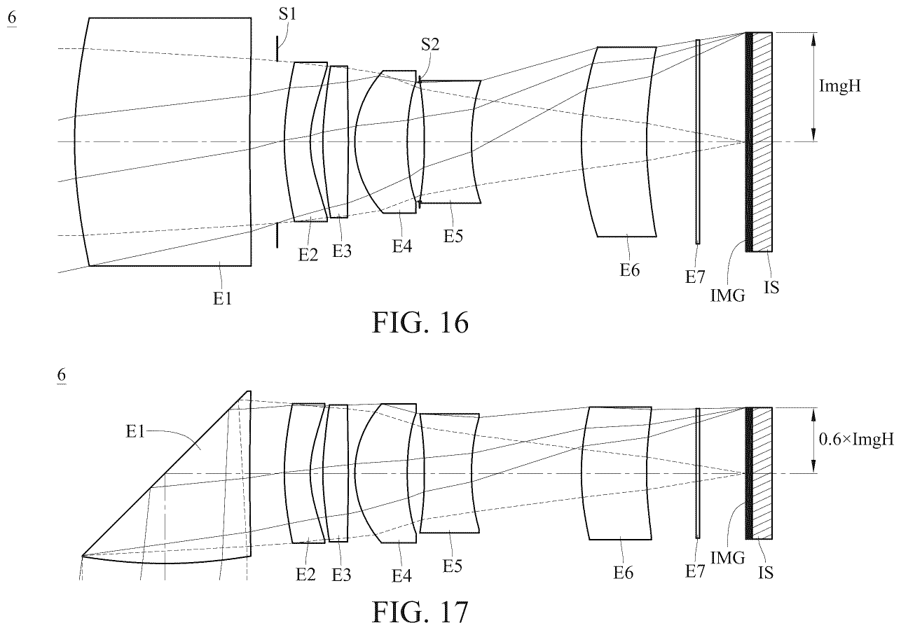

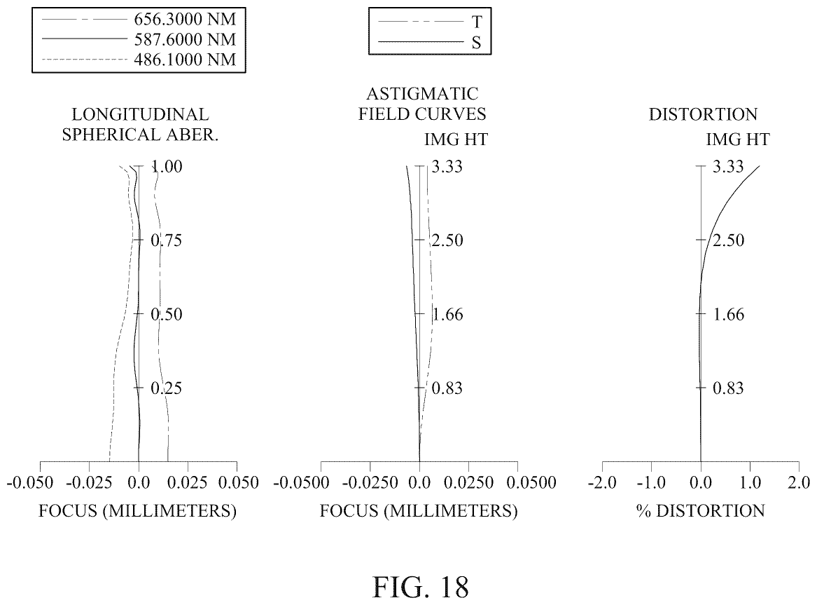

FIG. 16 is a cross-sectional schematic view of an image capturing unit according to the 6th embodiment of the present disclosure, corresponding to a diagonal direction of an effective photosensitive area of an image sensor. FIG. 17 is a cross-sectional schematic view of the image capturing unit according to the 6th embodiment of the present disclosure, corresponding to a short side direction of the effective photosensitive area of the image sensor, with an optical path folded by a first optical element. FIG. 18 shows, in order from left to right, spherical aberration according to the 6th embodiment. In FIG. 16 and FIG. 17, the image capturing unit 6 of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 16 does not depict the optical path folding effect caused by the first optical element E1. The optical path folding effect of the first optical element E1 is shown in FIG. 17.

The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The first optical element E1 with an optical path folding function has a reflective surface.

The second optical element E2 with negative refractive power has an object-side surface being convex in a paraxial region thereof and an image-side surface being concave in a paraxial region thereof. The second optical element E2 is a lens element made of plastic material and has the object-side surface and the image-side surface being both aspheric. The image-side surface of the second optical element E2 has one inflection point.

The third optical element E3 with positive refractive power has an object-side surface being convex in a paraxial region thereof and an image-side surface being convex in a paraxial region thereof. The third optical element E3 is a lens element made of plastic material and has the object-side surface and the image-side surface being both aspheric. The object-side surface of the third optical element E3 has one inflection point. The image-side surface of the third optical element E3 has two inflection points.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 6th embodiment are shown in Table 6A and the aspheric surface data are shown in Table 6B below.

TABLE 6A
6th Embodiment
f = 15.10 mm, f/EPDmax = 2.66, HFOV = 12.3 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 14.0845 | (ASP) | 5.320 | Plastic | 1.544 | 56.0 | 29.91 |
| 2 | | 90.9091 | (ASP) | 0.830 | | | | |
| 3 | Stop | Plano | | 0.218 | | | | |
| 4 | Optic 2 | 7.3115 | (ASP) | 0.786 | Plastic | 1.529 | 45.4 | −11.01 |
| 5 | | 3.1216 | (ASP) | 0.382 | | | | |
| 6 | Optic 3 | 6.9724 | (ASP) | 0.775 | Plastic | 1.544 | 55.9 | 11.04 |
| 7 | | −41.2793 | (ASP) | 0.200 | | | | |
| 8 | Optic 4 | 3.2145 | (ASP) | 1.588 | Plastic | 1.544 | 56.0 | 9.20 |
| 9 | | 7.4210 | (ASP) | 0.375 | | | | |
| 10 | Stop | Plano | | 0.147 | | | | |
| 11 | Optic 5 | −14.1647 | (ASP) | 1.430 | Plastic | 1.639 | 23.5 | −6.95 |
| 12 | | 6.7239 | (ASP) | 3.336 | | | | |
| 13 | Optic 6 | 7.3469 | (ASP) | 1.980 | Plastic | 1.697 | 16.3 | 28.94 |
| 14 | | 10.2744 | (ASP) | 1.500 | | | | |

| | | | | | | | |
|---|---|---|---|---|---|---|---|
| 15 | Filter | Plano | 0.110 | Glass | 1.517 | 64.2 | — |
| 16 | | Plano | 1.401 | | | | |
| 17 | Image | Plano | — | | | | |

Note:
Reference wavelength is 587.6 nm (d-line).
An effective radius of the stop S1 (Surface 3) is 2.464 mm.
An effective radius of the stop S2 (Surface 10) is 1.813 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 6B
Aspheric Coefficients

| Surface # | 1 | 2 | 4 | 5 | 6 | 7 |
|---|---|---|---|---|---|---|
| k= | −5.73761E+00 | −9.00000E+01 | −6.07765E+00 | −5.97965E+00 | −3.38627E+01 | −8.60192E+01 |
| A4= | −1.188E−04 | −3.740E−05 | −3.560E−03 | 2.413E−03 | 8.895E−04 | 9.706E−04 |
| A6= | — | — | 6.682E−04 | −3.083E−03 | −1.896E−03 | 3.426E−04 |
| A8= | — | — | −6.331E−05 | 6.773E−04 | 5.989E−04 | −4.828E−05 |
| A10= | — | — | 2.142E−06 | −5.011E−05 | −5.269E−05 | −2.428E−06 |

| Surface # | 8 | 9 | 11 | 12 | 13 | 14 |
|---|---|---|---|---|---|---|
| k= | 2.11158E−01 | 8.25761E+00 | −7.08594E+01 | 5.05502E+00 | 1.51536E+00 | 4.75129E+00 |
| A4= | 2.671E−03 | −4.139E−03 | −1.014E−02 | −3.494E−03 | −3.347E−03 | −3.977E−03 |
| A6= | −7.258E−04 | 1.435E−03 | 3.002E−03 | 1.621E−03 | 2.083E−04 | 2.184E−04 |
| A8= | 3.188E−06 | −3.393E−06 | −3.482E−04 | −2.940E−04 | −5.759E−06 | −4.848E−06 |
| A10= | −9.499E−07 | −2.267E−05 | 6.923E−06 | 7.022E−06 | 2.132E−09 | 1.018E−07 |

In the 6th embodiment, the equation of the aspheric surface profiles of the aforementioned optical elements is the same as the equation of the 1st embodiment. Also, the definitions of these parameters shown in Table 6C below are the same as those stated in the 1st embodiment, with corresponding values for the 6th embodiment; therefore, an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f [mm] | 15.10 | (R7 + R9)/(R7 − R9) | −0.63 |
| f/EPDmax | 2.66 | (ΣAT + BL)/ΣCT | 0.72 |
| HFOV [deg.] | 12.3 | (CT2 + CT3 + CT4 + | 1.23 |
| | | CT5 + CT6)/CT1 | |
| FOV [deg.] | 24.6 | 10 × CT3/f | 0.51 |
| f/f1 | 0.51 | 10 × CT3/CT1 | 1.46 |
| f4/f | 0.61 | T23/CT2 | 0.49 |
| f/f23 | 0.0020 | V5/V6 | 1.44 |
| f/f56 | −1.55 | N1 | 1.544 |
| f/f5 + f/f6 | −1.65 | N2 | 1.529 |
| R10/f6 | 0.23 | N4 | 1.544 |
| \|R7/R1\| | 0.23 | Y1R1/ImgH | 1.13 |
| \|R3/R2\| | 0.08 | (SAG1R1 + SAG1R2)/ET1 | 0.10 |
| \|R7/R2\| | 0.04 | (SAG5R1 + SAG5R2)/CT5 | 0.10 |
| R12/R7 | 3.20 | SAG6R2/CT6 | 0.15 |
| (\|R7\| + \|R9\|)/\|R2\| | 0.19 | P1TL/TL | 0.87 |
| (R3 + R12)/(R3 − R12) | −5.94 | — | — |

### 7th Embodiment

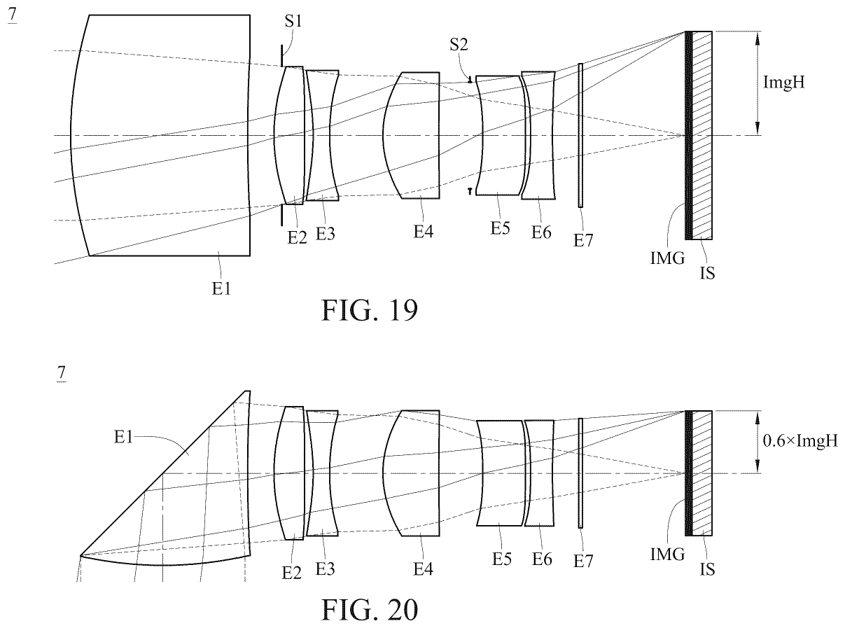

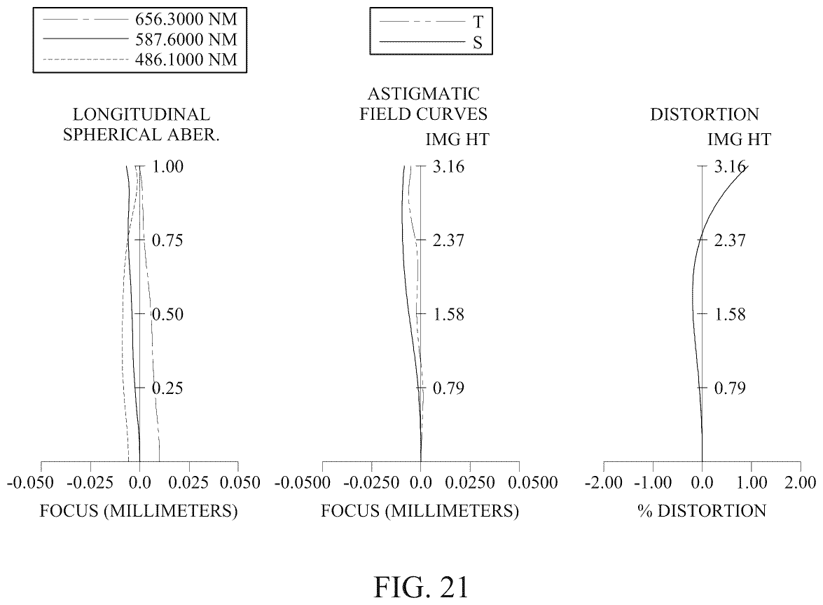

FIG. 19 is a cross-sectional schematic view of an image capturing unit according to the 7th embodiment of the present disclosure, corresponding to a diagonal direction of an effective photosensitive area of an image sensor. FIG. 20 is a cross-sectional schematic view of the image capturing unit according to the 7th embodiment of the present disclosure, corresponding to a short side direction of the effective photosensitive area of the image sensor, with an optical path folded by a first optical element. FIG. 21 shows, in order from left to right, spherical aberration according to the 7th embodiment. In FIG. 19 and FIG. 20, the image capturing unit 7 of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 19 does not depict the optical path folding effect caused by the first optical element E1. The optical path folding effect of the first optical element E1 is shown in FIG. 20.

The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The first optical element E1 with an optical path folding function has a reflective surface.

The second optical element E2 with positive refractive power has an object-side surface being convex in a paraxial region thereof and an image-side surface being convex in a paraxial region thereof. The second optical element E2 is a lens element made of plastic material and has the object-side surface and the image-side surface being both aspheric. The object-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric. The image-side surface of the fourth optical element E4 has two inflection points.

The fifth optical element E5 with negative refractive power has an object-side surface being concave in a paraxial region thereof and an image-side surface being convex in a paraxial region thereof. The fifth optical element E5 is a lens element made of plastic material and has the object-side surface and the image-side surface being both aspheric.

The sixth optical element E6 with negative refractive power has an object-side surface being concave in a paraxial region thereof and an image-side surface being concave in a paraxial region thereof. The sixth optical element E6 is a lens element made of plastic material and has the object-side surface and the image-side surface being both aspheric. The image-side surface of the sixth optical element E6 has two inflection points.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 7th embodiment are shown in Table 7A and the aspheric surface data are shown in Table 7B below.

TABLE 7A
7th Embodiment
f = 13.85 mm, f/EPDmax = 2.68, HFOV = 12.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 11.0679 | (ASP) | 5.380 | Plastic | 1.544 | 56.0 | 24.42 |
| 2 | | 54.9566 | (ASP) | 1.040 | | | | |
| 3 | Stop | Plano | | −0.240 | | | | |
| 4 | Optic 2 | 5.9432 | (ASP) | 0.931 | Plastic | 1.544 | 56.0 | 10.04 |
| 5 | | −63.4745 | (ASP) | 0.259 | | | | |
| 6 | Optic 3 | −6.1339 | (ASP) | 0.500 | Plastic | 1.614 | 26.0 | −5.23 |
| 7 | | 6.9375 | (ASP) | 1.618 | | | | |
| 8 | Optic 4 | 3.0799 | (ASP) | 1.700 | Plastic | 1.566 | 37.4 | 5.69 |
| 9 | | 57.2441 | (ASP) | 0.945 | | | | |
| 10 | Stop | Plano | | 0.392 | | | | |
| 11 | Optic 5 | −9.8032 | (ASP) | 1.293 | Plastic | 1.511 | 56.8 | −22.14 |
| 12 | | −76.9231 | (ASP) | 0.157 | | | | |
| 13 | Optic 6 | −21.2800 | (ASP) | 0.663 | Plastic | 1.566 | 37.4 | −14.47 |
| 14 | | 13.4599 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 3.136 | | | | |
| 17 | Image | Plano | — | | | | |

Note:
Reference wavelength is 587.6 nm (d-line).
An effective radius of the stop S1 (Surface 3) is 2.103 mm.
An effective radius of the stop S2 (Surface 10) is 1.620 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 7B
Aspheric Coefficients

| Surface # | 1 | 2 | 4 | 5 | 6 | 7 |
|---|---|---|---|---|---|---|
| k= | −9.67928E−01 | −7.86992E+01 | −1.72735E+00 | 8.63813E+01 | −1.96569E+01 | 6.82942E+00 |
| A4= | −2.058E−04 | 5.390E−04 | 2.422E−03 | 3.973E−03 | 1.887E−03 | −2.606E−03 |
| A6= | — | — | −2.757E−04 | −1.890E−03 | 2.197E−04 | 1.052E−03 |
| A8= | — | — | −4.943E−05 | 1.694E−04 | −1.029E−04 | −1.994E−04 |
| A10= | — | — | 9.380E−07 | −8.186E−06 | 4.476E−06 | −1.389E−05 |

| Surface # | 8 | 9 | 11 | 12 | 13 | 14 |
|---|---|---|---|---|---|---|
| k= | −4.54942E−01 | 9.00000E+01 | −1.59753E+00 | 9.00000E+01 | 7.07441E+01 | 2.38083E+01 |
| A4= | −6.453E−03 | −2.500E−03 | −4.498E−03 | −3.098E−03 | −2.289E−02 | −2.089E−02 |
| A6= | 7.614E−04 | −1.154E−04 | −3.603E−03 | −6.821E−03 | 2.089E−03 | 5.790E−03 |
| A8= | −2.671E−05 | 1.888E−04 | 8.777E−04 | 9.160E−04 | 8.553E−05 | −4.646E−04 |
| A10= | 3.765E−06 | −1.128E−05 | −1.076E−04 | −5.439E−05 | −3.854E−05 | 2.931E−07 |

In the 7th embodiment, the equation of the aspheric surface profiles of the aforementioned optical elements is the same as the equation of the 1st embodiment. Also, the definitions of these parameters shown in Table 7C below are the same as those stated in the 1st embodiment, with corresponding values for the 7th embodiment; therefore, an explanation in this regard will not be provided again.

Moreover, these parameters can be calculated from Table 7A and Table 7B as the following values and satisfy the following conditions:

TABLE 7C
Values of Optical and Physical Parameters/Definitions

| | | | |
|---|---|---|---|
| f [mm] | 13.85 | (R7 + R9)/(R7 − R9) | −0.52 |
| f/EPDmax | 2.68 | (ΣAT + BL)/ΣCT | 0.79 |
| HFOV [deg.] | 12.7 | (CT2 + CT3 + CT4 + | 0.95 |
| | | CT5 + CT6)/CT1 | |
| FOV [deg.] | 25.4 | 10 × CT3/f | 0.36 |
| f/f1 | 0.57 | 10 × CT3/CT1 | 0.93 |
| f4/f | 0.41 | T23/CT2 | 0.28 |
| f/f23 | −1.02 | V5/V6 | 1.52 |
| f/f56 | −1.64 | N1 | 1.544 |
| f/f5 + f/f6 | −1.58 | N2 | 1.544 |
| R10/f6 | 5.32 | N4 | 1.566 |
| \|R7/R1\| | 0.28 | Y1R1/ImgH | 1.16 |
| \|R3/R2\| | 0.11 | (SAG1R1 + SAG1R2)/ET1 | 0.13 |
| \|R7/R2\| | 0.06 | (SAG5R1 + SAG5R2)/CT5 | −0.32 |
| R12/R7 | 4.37 | SAG6R2/CT6 | 0.13 |
| (\|R7\| + \|R9\|)/\|R2\| | 0.23 | P1TL/TL | 0.85 |
| (R3 + R12)/(R3 − R12) | −2.58 | — | — |

### 8th Embodiment

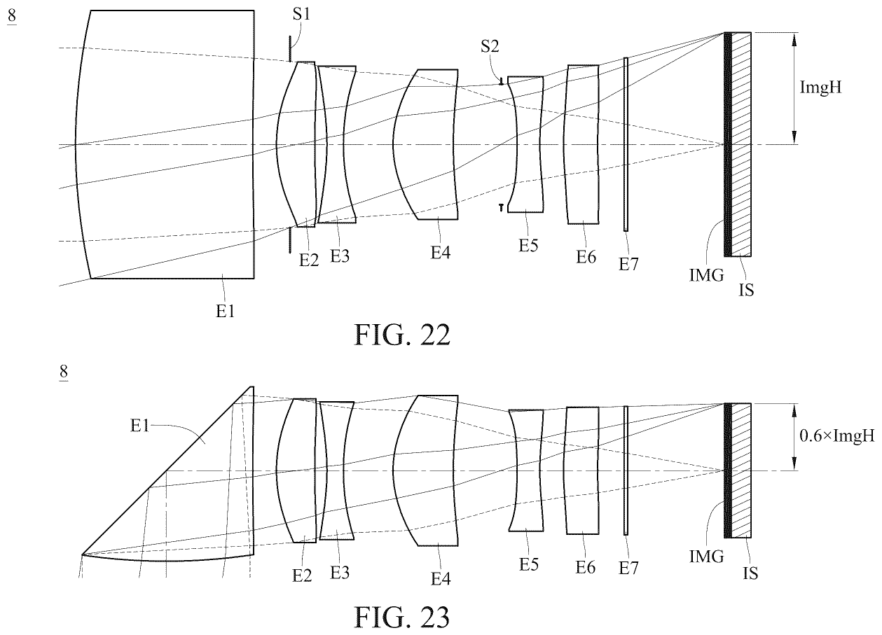

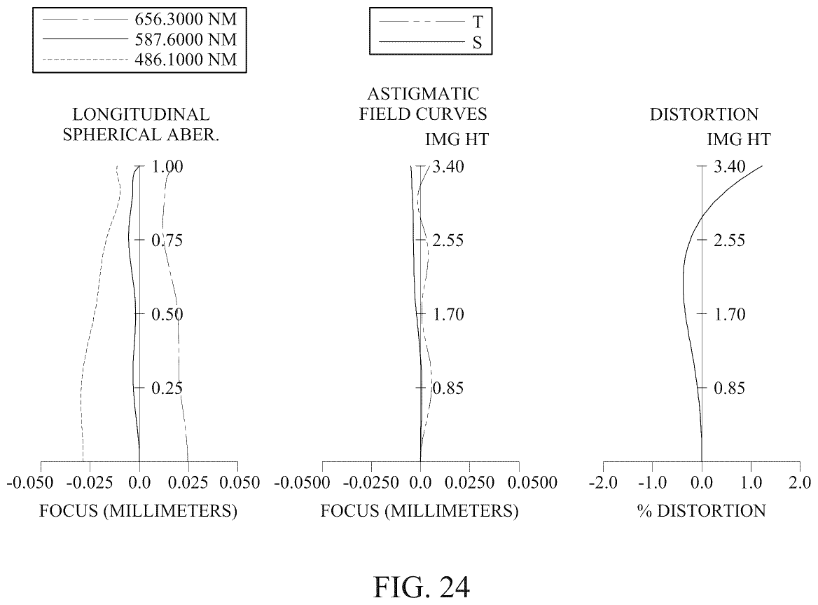

FIG. 22 is a cross-sectional schematic view of an image capturing unit according to the 8th embodiment of the present disclosure, corresponding to a diagonal direction of an effective photosensitive area of an image sensor. FIG. 23 is a cross-sectional schematic view of the image capturing unit according to the 8th embodiment of the present disclosure, corresponding to a short side direction of the effective photosensitive area of the image sensor, with an optical path folded by a first optical element. FIG. 24 shows, in order from left to right, spherical aberration according to the 8th embodiment. In FIG. 22 and FIG. 23, the image capturing unit 8 of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 22 does not depict the optical path folding effect caused by the first optical element E1. The optical path folding effect of the first optical element E1 is shown in FIG. 23.

The first optical element E1 with positive refractive power has an object-side surface being convex in a paraxial region thereof and an image-side surface being concave in a paraxial region thereof. The first optical element E1 is a prism made of glass material and has the object-side surface and the image-side surface being both aspheric. The image-side surface of the first optical element E1 has one inflection point. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of glass material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric. The image-side surface of the third optical element E3 has one inflection point.

The fourth optical element E4 with positive refractive power has an object-side surface being convex in a paraxial region thereof and an image-side surface being concave in a paraxial region thereof. The fourth optical element E4 is a lens element made of glass material and has the object-side surface and the image-side surface being both aspheric.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has two inflection points. The image-side surface of the sixth optical element E6 has two inflection points.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 8th embodiment are shown in Table 8A and the aspheric surface data are shown in Table 8B below.

TABLE 8A
8th Embodiment
f = 14.56 mm, f/EPDmax = 2.48, HFOV = 13.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 17.2775 | (ASP) | 5.382 | Glass | 1.589 | 61.3 | 36.60 |
| 2 | | 76.9231 | (ASP) | 1.132 | | | | |
| 3 | Stop | Plano | | −0.412 | | | | |
| 4 | Optic 2 | 4.4950 | (ASP) | 1.163 | Glass | 1.517 | 64.2 | 10.26 |
| 5 | | 26.8829 | (ASP) | 0.370 | | | | |
| 6 | Optic 3 | −6.9369 | (ASP) | 0.500 | Plastic | 1.566 | 37.4 | −6.09 |
| 7 | | 7.0381 | (ASP) | 1.507 | | | | |
| 8 | Optic 4 | 3.2521 | (ASP) | 1.830 | Glass | 1.569 | 56.0 | 7.17 |
| 9 | | 12.8032 | (ASP) | 1.451 | | | | |
| 10 | Stop | Plano | | 0.484 | | | | |
| 11 | Optic 5 | −15.0162 | (ASP) | 0.693 | Plastic | 1.566 | 37.4 | −9.59 |
| 12 | | 8.6506 | (ASP) | 0.719 | | | | |
| 13 | Optic 6 | 8.4506 | (ASP) | 1.036 | Plastic | 1.669 | 19.5 | 33.43 |
| 14 | | 12.9160 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 2.944 | | | | |
| 17 | Image | Plano | — | | | | |

Note:
Reference wavelength is 587.6 nm (d-line).
An effective radius of the stop S1 (Surface 3) is 2.527 mm.
An effective radius of the stop S2 (Surface 10) is 1.830 mm.
The first optical element E1 is a prism having refractive power.
The photographing optical lens assembly can further include an aperture stop, and the position of
the aperture stop can be adjusted depending on the arrangement of the front reflective element (the
first optical element E1) or the trimmed edge(s) of lens element(s).

TABLE 8B
Aspheric Coefficients

| Surface # | 1 | 2 | 4 | 5 | 6 | 7 |
|---|---|---|---|---|---|---|
| k= | −1.47768E+00 | 8.56453E+01 | −1.69842E+00 | −1.80599E+01 | −1.92223E+01 | 4.61292E+00 |
| A4= | −8.838E−05 | −2.411E−04 | 1.709E−03 | −1.174E−04 | 2.057E−03 | −5.583E−04 |
| A6= | 2.844E−06 | −6.471E−06 | −1.252E−04 | −3.201E−04 | −2.822E−04 | −3.199E−04 |
| A8= | — | — | −1.775E−05 | −4.840E−05 | 3.700E−05 | 8.939E−05 |
| A10= | — | — | −2.956E−06 | 2.557E−06 | −7.169E−06 | −1.975E−05 |
| A12= | — | — | −7.075E−08 | — | 3.957E−07 | 5.156E−07 |

| Surface # | 8 | 9 | 11 | 12 | 13 | 14 |
|---|---|---|---|---|---|---|
| k= | −5.72790E−01 | 2.12907E+01 | −5.70433E+00 | 8.04004E+00 | −1.12365E+00 | 1.21070E+01 |
| A4= | −5.130E−03 | −2.962E−03 | −9.072E−03 | −9.880E−03 | −1.671E−02 | −1.620E−02 |
| A6= | 3.629E−04 | −4.878E−04 | −1.921E−03 | 7.928E−04 | 3.550E−03 | 2.599E−03 |
| A8= | −1.611E−05 | 8.222E−05 | −1.973E−04 | −8.489E−04 | −6.026E−04 | −3.245E−04 |
| A10= | 2.985E−06 | −3.345E−07 | 1.286E−04 | 2.512E−04 | 7.879E−05 | 3.423E−05 |
| A12= | — | — | −1.092E−05 | −3.108E−05 | −4.108E−06 | −1.313E−06 |
| A14= | — | — | — | 1.413E−06 | — | — |

In the 8th embodiment, the equation of the aspheric surface profiles of the aforementioned optical elements is the same as the equation of the 1st embodiment.

Also, the definitions of these parameters shown in Table 8C below are the same as those stated in the 1st embodiment, with corresponding values for the 8th embodiment; therefore, an explanation in this regard will not be provided again. Moreover, these parameters can be calculated from Table 8A and Table 8B as the following values and satisfy the following conditions:

TABLE 8C
Values of Optical and Physical Parameters/Definitions

| | | | |
|---|---|---|---|
| f [mm] | 14.56 | (R7 + R9)/(R7 − R9) | −0.64 |
| f/EPDmax | 2.48 | (ΣAT + BL)/ΣCT | 0.86 |
| HFOV [deg.] | 13.0 | (CT2 + CT3 + CT4 + | 0.97 |
| | | CT5 + CT6)/CT1 | |
| FOV [deg.] | 26.0 | 10 × CT3/f | 0.34 |
| f/f1 | 0.40 | 10 × CT3/CT1 | 0.93 |
| f4/f | 0.49 | T23/CT2 | 0.32 |
| f/f23 | −0.64 | V5/V6 | 1.92 |
| f/f56 | −1.09 | N1 | 1.589 |
| f/f5 + f/f6 | −1.08 | N2 | 1.517 |
| R10/f6 | 0.26 | N4 | 1.569 |
| \|R7/R1\| | 0.19 | Y1R1/ImgH | 1.20 |
| \|R3/R2\| | 0.06 | (SAG1R1 + SAG1R2)/ET1 | 0.10 |
| \|R7/R2\| | 0.04 | (SAG5R1 + SAG5R2)/CT5 | −0.26 |
| R12/R7 | 3.97 | SAG6R2/CT6 | 0.03 |
| (\|R7\| + \|R9\|)/\|R2\| | 0.24 | P1TL/TL | 0.86 |
| (R3 + R12)/(R3 − R12) | −2.07 | — | — |

### 9th Embodiment

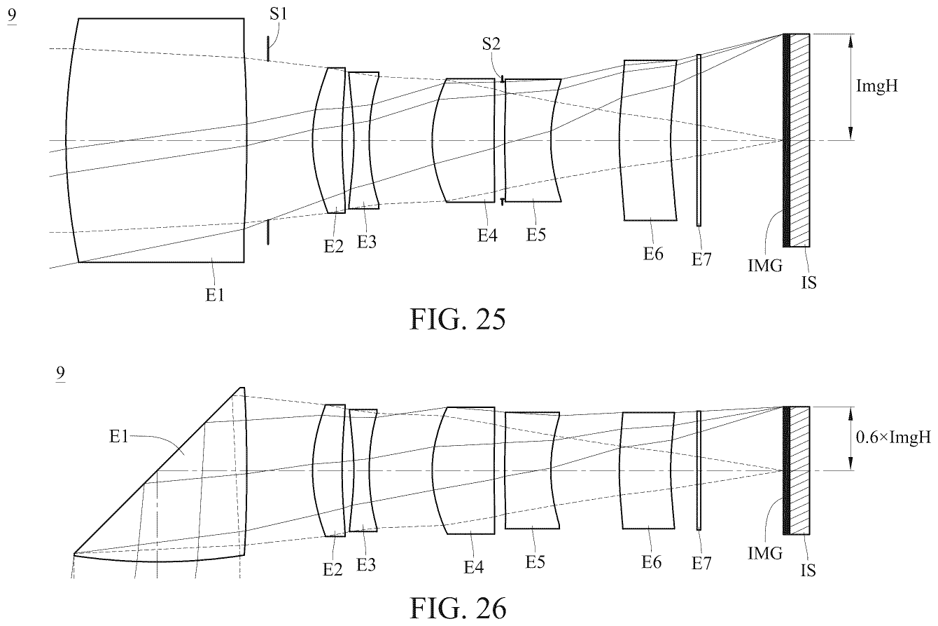

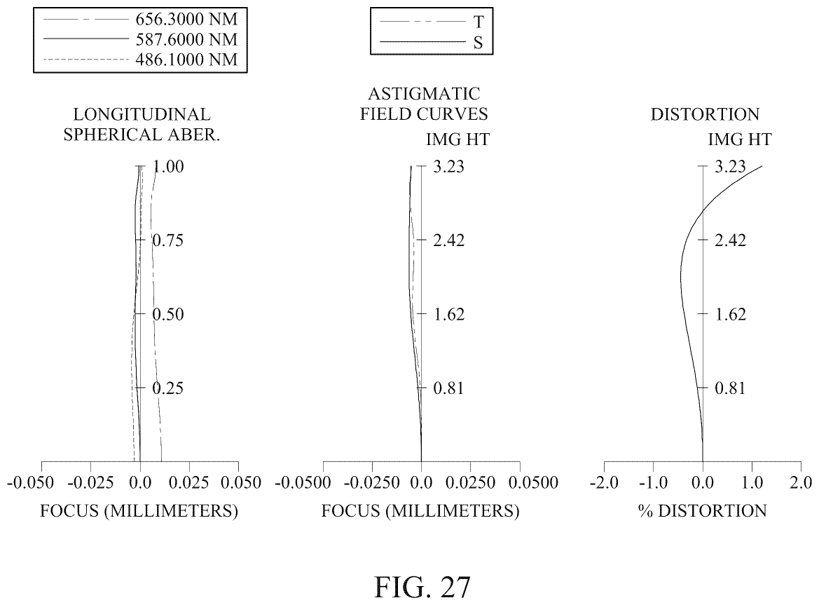

FIG. 25 is a cross-sectional schematic view of an image capturing unit according to the 9th embodiment of the present disclosure, corresponding to a diagonal direction of an effective photosensitive area of an image sensor. FIG. 26 is a cross-sectional schematic view of the image capturing unit according to the 9th embodiment of the present disclosure, corresponding to a short side direction of the effective photosensitive area of the image sensor, with an optical path folded by a first optical element. FIG. 27 shows, in order from left to right, spherical aberration curves, astigmatic field curves and a distortion curve of the image capturing unit according to the 9th embodiment. In FIG. 25 and FIG. 26, the image capturing unit 9 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 25 does not depict the optical path folding effect caused by the first optical element E1. The optical path folding effect of the first optical element E1 is shown in FIG. 26.

The first optical element E1 with positive refractive power has an object-side surface being convex in a paraxial region thereof and an image-side surface being convex in a paraxial region thereof. The first optical element E1 is a prism made of plastic material and has the object-side surface and the image-side surface being both aspheric. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric. The object-side surface of the third optical element E3 has two inflection points.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric. The image-side surface of the fourth optical element E4 has one inflection point.

The fifth optical element E5 with negative refractive power has an object-side surface being convex in a paraxial region thereof and an image-side surface being concave in a paraxial region thereof. The fifth optical element E5 is a lens element made of plastic material and has the object-side surface and the image-side surface being both aspheric. The object-side surface of the fifth optical element E5 has one inflection point. The image-side surface of the fifth optical element E5 has one inflection point.

The sixth optical element E6 with negative refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has two inflection points. The image-side surface of the sixth optical element E6 has two inflection points.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 9th embodiment are shown in Table 9A and the aspheric surface data are shown in Table 9B below.

TABLE 9A
9th Embodiment
f = 15.60 mm, f/EPDmax = 2.80, HFOV = 11.6 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 16.6427 | (ASP) | 5.494 | Plastic | 1.534 | 56.0 | 24.25 |
| 2 | | −51.7468 | (ASP) | 0.650 | | | | |
| 3 | Stop | Plano | | 1.350 | | | | |
| 4 | Optic 2 | 4.8933 | (ASP) | 0.899 | Plastic | 1.544 | 55.9 | 12.21 |
| 5 | | 17.4313 | (ASP) | 0.356 | | | | |
| 6 | Optic 3 | −8.3813 | (ASP) | 0.466 | Plastic | 1.584 | 28.2 | −6.38 |
| 7 | | 6.8475 | (ASP) | 1.913 | | | | |
| 8 | Optic 4 | 3.7721 | (ASP) | 1.883 | Plastic | 1.551 | 44.8 | 7.50 |
| 9 | | 35.7715 | (ASP) | 0.251 | | | | |
| 10 | Stop | Plano | | 0.071 | | | | |
| 11 | Optic 5 | 20.9831 | (ASP) | 1.401 | Plastic | 1.511 | 56.8 | −12.83 |
| 12 | | 4.8803 | (ASP) | 2.081 | | | | |
| 13 | Optic 6 | 9.1104 | (ASP) | 1.562 | Plastic | 1.615 | 25.4 | −1591.26 |
| 14 | | 8.4372 | (ASP) | 0.800 | | | | |

| | | | | | | | |
|---|---|---|---|---|---|---|---|
| 15 | Filter | Plano | 0.110 | Glass | 1.517 | 64.2 | — |
| 16 | | Plano | 2.510 | | | | |
| 17 | Image | Plano | — | | | | |

Note:
Reference wavelength is 587.6 nm (d-line).
An effective radius of the stop S1 (Surface 3) is 2.419 mm.
An effective radius of the stop S2 (Surface 10) is 1.778 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 9B
Aspheric Coefficients

| Surface # | 1 | 2 | 4 | 5 | 6 | 7 |
|---|---|---|---|---|---|---|
| k= | −4.22200E−01 | 7.14858E+01 | −2.01921E+00 | −2.48970E−01 | −2.79144E+01 | 5.51371E+00 |
| A4= | −1.498E−04 | −1.900E−04 | 1.911E−03 | 1.980E−03 | 1.768E−03 | −3.227E−03 |
| A6= | — | — | −2.923E−04 | −1.059E−03 | 4.168E−04 | 1.086E−03 |
| A8= | — | — | −3.702E−05 | 6.609E−05 | −9.416E−05 | −2.103E−04 |
| A10= | — | — | −1.078E−06 | −5.022E−06 | 3.266E−06 | −1.944E−07 |

| Surface # | 8 | 9 | 11 | 12 | 13 | 14 |
|---|---|---|---|---|---|---|
| k= | −4.34262E−01 | −2.82413E+01 | 6.27052E+01 | 1.52541E+00 | 4.73582E+00 | 4.47192E+00 |
| A4= | −5.845E−03 | −3.419E−03 | −3.775E−03 | −4.450E−03 | −9.892E−03 | −1.110E−02 |
| A6= | 5.236E−04 | −4.583E−04 | −1.381E−03 | −2.693E−04 | 8.280E−04 | 1.049E−03 |
| A8= | 2.956E−05 | 2.785E−04 | 2.031E−04 | −1.501E−04 | −2.332E−05 | −6.170E−05 |
| A10= | −4.090E−06 | −3.390E−05 | −3.313E−05 | 1.480E−05 | 1.021E−06 | 3.709E−06 |

In the 9th embodiment, the equation of the aspheric surface profiles of the aforementioned optical elements is the same as the equation of the 1st embodiment. Also, the definitions of these parameters shown in Table 9C below are the same as those stated in the 1st embodiment, with corresponding values for the 9th embodiment; therefore, an explanation in this regard will not be provided again. Moreover, these parameters can be calculated from Table 9A and Table 9B as the following values and satisfy the following conditions:

TABLE 9C
Values of Optical and Physical Parameters/Definitions

| | | | |
|---|---|---|---|
| f [mm] | 15.60 | (R7 + R9)/(R7 − R9) | −1.44 |
| f/EPDmax | 2.80 | (ΣAT + BL)/ΣCT | 0.86 |
| HFOV [deg.] | 11.6 | (CT2 + CT3 + CT4 + | 1.13 |
| | | CT5 + CT6)/CT1 | |
| FOV [deg.] | 23.2 | 10 × CT3/f | 0.30 |
| f/f1 | 0.64 | 10 × CT3/CT1 | 0.85 |
| f4/f | 0.48 | T23/CT2 | 0.40 |
| f/f23 | −0.91 | V5/V6 | 2.24 |
| f/f56 | −1.31 | N1 | 1.534 |
| f/f5 + f/f6 | −1.23 | N2 | 1.544 |
| R10/f6 | −0.0031 | N4 | 1.551 |
| \|R7/R1\| | 0.23 | Y1R1/ImgH | 1.14 |
| \|R3/R2\| | 0.09 | (SAG1R1 + SAG1R2)/ET1 | 0.06 |
| \|R7/R2\| | 0.07 | (SAG5R1 + SAG5R2)/CT5 | 0.24 |
| R12/R7 | 2.24 | SAG6R2/CT6 | 0.12 |
| (\|R7\| + \|R9\|)/\|R2\| | 0.48 | P1TL/TL | 0.87 |
| (R3 + R12)/(R3 − R12) | −3.76 | — | — |

### 10th Embodiment

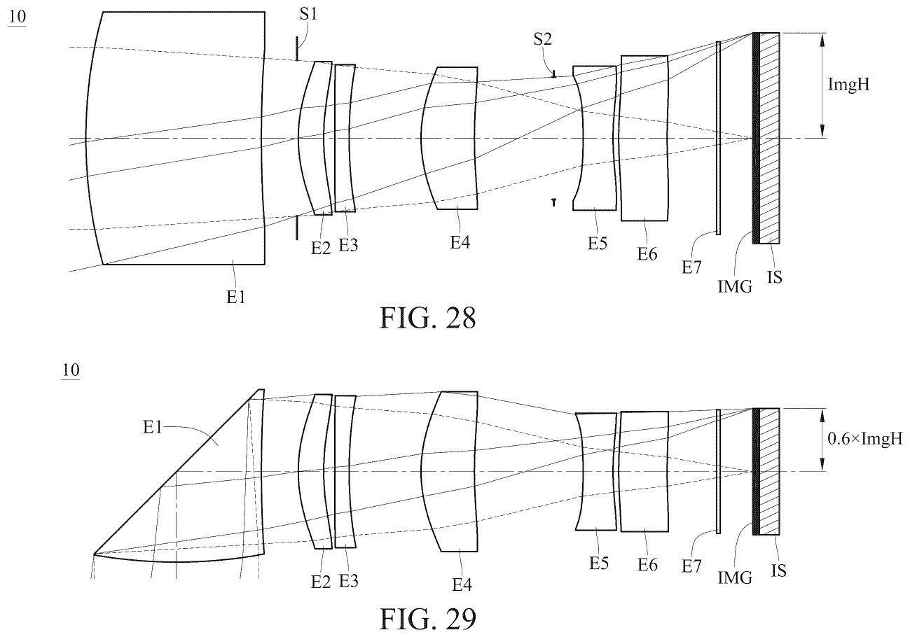

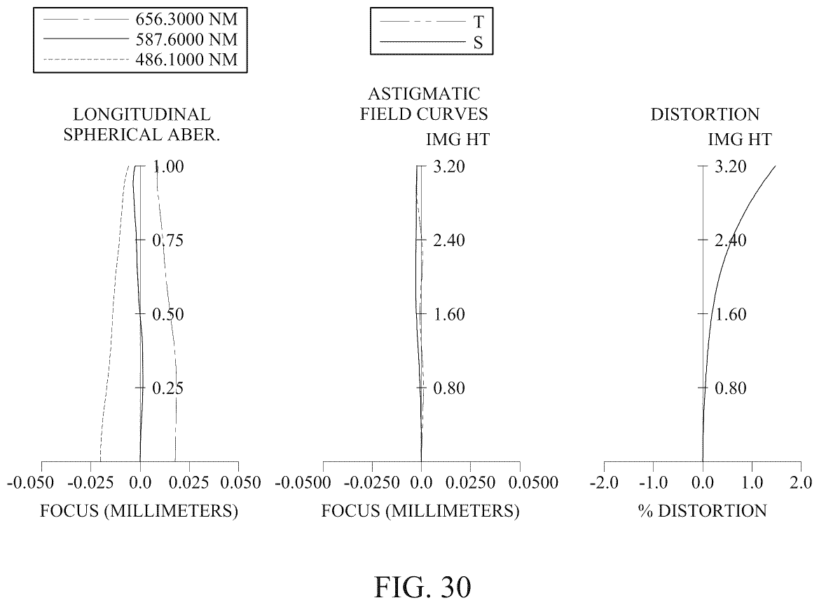

FIG. 28 is a cross-sectional schematic view of an image capturing unit according to the 10th embodiment of the present disclosure, corresponding to a diagonal direction of an effective photosensitive area of an image sensor. FIG. 29 is a cross-sectional schematic view of the image capturing unit according to the 10th embodiment of the present disclosure, corresponding to a short side direction of the effective photosensitive area of the image sensor, with an optical path folded by a first optical element. FIG. 30 shows, in order from left to right, spherical aberration curves, astigmatic field curves and a distortion curve of the image capturing unit according to the 10th embodiment. In FIG. 28 and FIG. 29, the image capturing unit 10 includes the photographing optical lens assembly (its reference numeral is omitted) of the present disclosure and an image sensor IS. The photographing optical lens assembly includes, in order from an object side to an image side along an optical path, a first optical element E1, a stop S1, a second optical element E2, a third optical element E3, a fourth optical element E4, a stop S2, a fifth optical element E5, a sixth optical element E6, a filter E7 and an image surface IMG. Additionally, the image sensor IS is configured as a rectangular element with an aspect ratio of 4:3, but the present disclosure is not limited thereto. For example, the image sensor IS can be configured as a rectangular element with an aspect ratio of 16:9, or a rectangular element with an aspect ratio of 16:10. The photographing optical lens assembly includes six optical elements (E1, E2, E3, E4, E5 and E6) with no additional optical element disposed between each of the adjacent six optical elements. To simplify the illustration of the refractive effect of the first optical element E1 on the light rays, FIG. 28 does not depict the optical path folding effect caused by the first optical element E1. The optical path folding effect of the first optical element E1 is shown in FIG. 29.

The first optical element E1 with positive refractive power has an object-side surface being convex in a paraxial region thereof and an image-side surface being concave in a paraxial region thereof. The first optical element E1 is a prism made of plastic material and has the object-side surface and the image-side surface being both aspheric. The first optical element E1 with an optical path folding function has a reflective surface.

The second optical element E2 with positive refractive power has an object-side surface being convex in a paraxial region thereof and an image-side surface being concave in a paraxial region thereof. The second optical element E2 is a lens element made of plastic material and has the object-side surface and the image-side surface being both aspheric. The object-side surface of the second optical element E2 has one inflection point. The image-side surface of the second optical element E2 has one inflection point.

The third optical element E3 with negative refractive power has an object-side surface being concave in a paraxial region thereof and an image-side surface being concave in a paraxial region thereof. The third optical element E3 is a lens element made of plastic material and has the object-side surface and the image-side surface being both aspheric. The object-side surface of the third optical element E3 has two inflection points.

The fourth optical element E4 with positive refractive power has an object-side surface being convex in a paraxial region thereof and an image-side surface being concave in a paraxial region thereof. The fourth optical element E4 is a lens element made of plastic material and has the object-side surface and the image-side surface being both aspheric. The image-side surface of the fourth optical element E4 has one inflection point.

The fifth optical element E5 with negative refractive power has an object-side surface being concave in a paraxial region thereof and an image-side surface being concave in a paraxial region thereof. The fifth optical element E5 is a lens element made of plastic material and has the object-side surface and the image-side surface being both aspheric. The image-side surface of the fifth optical element E5 has one inflection point.

The sixth optical element E6 with positive refractive power has an object-side surface being convex in a paraxial region thereof and an image-side surface being concave in a paraxial region thereof. The sixth optical element E6 is a lens element made of plastic material and has the object-side surface and the image-side surface being both aspheric. The object-side surface of the sixth optical element E6 has one inflection point. The image-side surface of the sixth optical element E6 has one inflection point.

The filter E7 is made of glass material and located between the sixth optical element E6 and the image surface IMG, and will not affect the focal length of the photographing optical lens assembly. The image sensor IS is disposed on or near the image surface IMG of the photographing optical lens assembly.

The detailed optical data of the 10th embodiment are shown in Table 10A and the aspheric surface data are shown in Table 10B below.

TABLE 10A
10th Embodiment
f = 14.84 mm, f/EPDmax = 2.68, HFOV = 12.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Optic 1 | 14.6599 | (ASP) | 5.329 | Plastic | 1.511 | 56.8 | 42.11 |
| 2 | | 40.3587 | (ASP) | 1.080 | | | | |
| 3 | Stop | Plano | | 0.041 | | | | |
| 4 | Optic 2 | 4.6731 | (ASP) | 0.771 | Plastic | 1.544 | 56.0 | 24.23 |
| 5 | | 6.8182 | (ASP) | 0.344 | | | | |
| 6 | Optic 3 | −524.3971 | (ASP) | 0.430 | Plastic | 1.660 | 20.4 | −20.49 |
| 7 | | 13.8874 | (ASP) | 2.183 | | | | |
| 8 | Optic 4 | 4.3303 | (ASP) | 1.620 | Plastic | 1.544 | 56.0 | 10.90 |
| 9 | | 13.9256 | (ASP) | 2.412 | | | | |
| 10 | Stop | Plano | | 0.888 | | | | |
| 11 | Optic 5 | −16.6889 | (ASP) | 0.910 | Plastic | 1.566 | 37.4 | −9.38 |
| 12 | | 7.9412 | (ASP) | 0.171 | | | | |
| 13 | Optic 6 | 11.3125 | (ASP) | 1.470 | Plastic | 1.697 | 16.3 | 57.00 |
| 14 | | 14.9704 | (ASP) | 1.500 | | | | |

| | | | | | | | |
|---|---|---|---|---|---|---|---|
| 15 | Filter | Plano | 0.110 | Glass | 1.517 | 64.2 | — |
| 16 | | Plano | 0.996 | | | | |
| 17 | Image | Plano | — | | | | |

Note:
Reference wavelength is 587.6 nm (d-line).
An effective radius of the stop S1 (Surface 3) is 2.365 mm.
An effective radius of the stop S2 (Surface 10) is 1.860 mm.
The first optical element E1 is a prism having refractive power.
The photographing optical lens assembly can further include an aperture stop, and the position of the aperture stop can be adjusted depending on the arrangement of the front reflective element (the first optical element E1) or the trimmed edge(s) of lens element(s).

TABLE 10B
Aspheric Coefficients

| Surface # | 1 | 2 | 4 | 5 | 6 | 7 |
|---|---|---|---|---|---|---|
| k= | −1.59009E+00 | 3.38164E+01 | −2.59541E+00 | −1.00150E+01 | 9.00000E+01 | 1.42072E+01 |
| A4= | 1.132E−04 | 8.062E−05 | 6.386E−04 | −5.634E−04 | −1.039E−03 | −1.711E−03 |
| A6= | — | — | −1.367E−04 | −2.479E−04 | 7.599E−04 | 6.767E−04 |
| A8= | — | — | −4.256E−05 | −3.871E−05 | −1.076E−04 | −9.404E−05 |
| A10= | — | — | 2.703E−06 | 3.480E−06 | 4.007E−06 | 2.450E−06 |

| Surface # | 8 | 9 | 11 | 12 | 13 | 14 |
|---|---|---|---|---|---|---|
| k= | −7.01437E−01 | 1.42996E+01 | 1.39787E+01 | 5.77309E+00 | 3.16964E+00 | 6.95432E+00 |
| A4= | −2.189E−03 | −3.518E−03 | −1.189E−02 | −1.182E−02 | −1.033E−02 | −9.787E−03 |
| A6= | −1.928E−05 | −2.054E−04 | −1.324E−03 | −3.103E−04 | 1.411E−03 | 1.139E−03 |
| A8= | −4.619E−06 | 8.405E−06 | 1.436E−04 | 1.103E−04 | −1.337E−04 | −8.096E−05 |
| A10= | −9.093E−08 | −5.101E−07 | 7.363E−06 | −7.054E−06 | 3.948E−06 | 1.878E−06 |

In the 10th embodiment, the equation of the aspheric surface profiles of the aforementioned optical elements is the same as the equation of the 1st embodiment. Also, the definitions of these parameters shown in Table 10C below are the same as those stated in the 1st embodiment, with corresponding values for the 10th embodiment; therefore, an explanation in this regard will not be provided again.

Moreover, these parameters can be calculated from Table 10A and Table 10B as the following values and satisfy the following conditions:

TABLE 10C
Values of Optical and Physical Parameters/Definitions

| | | | |
|---|---|---|---|
| f [mm] | 14.84 | (R7 + R9)/(R7 − R9) | −0.59 |
| f/EPDmax | 2.68 | (ΣAT + BL)/ΣCT | 0.92 |
| HFOV [deg.] | 12.0 | (CT2 + CT3 + CT4 + | 0.98 |
| | | CT5 + CT6)/CT1 | |
| FOV [deg.] | 24.0 | 10 × CT3/f | 0.29 |
| f/f1 | 0.35 | 10 × CT3/CT1 | 0.81 |
| f4/f | 0.73 | T23/CT2 | 0.45 |
| f/f23 | −0.05 | V5/V6 | 2.29 |
| f/f56 | −1.38 | N1 | 1.511 |
| f/f5 + f/f6 | −1.32 | N2 | 1.544 |
| R10/f6 | 0.14 | N4 | 1.544 |
| \|R7/R1\| | 0.30 | Y1R1/ImgH | 1.20 |
| \|R3/R2\| | 0.12 | (SAG1R1 + SAG1R2)/ET1 | 0.13 |
| \|R7/R2\| | 0.11 | (SAG5R1 + SAG5R2)/CT5 | −0.23 |
| R12/R7 | 3.46 | SAG6R2/CT6 | 0.01 |
| (\|R7\| + \|R9\|)/\|R2\| | 0.52 | P1TL/TL | 0.86 |
| (R3 + R12)/(R3 − R12) | −1.91 | — | — |

### 11th Embodiment

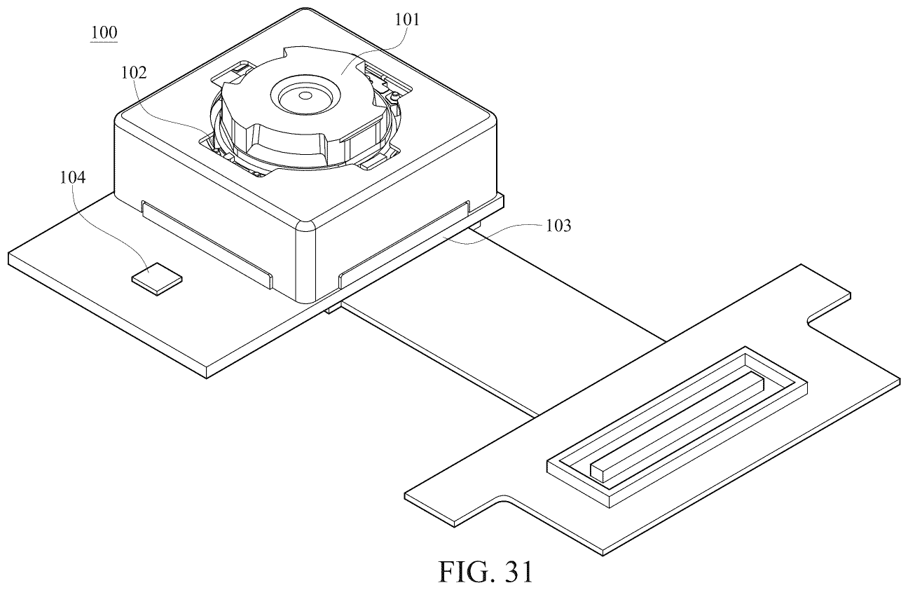

FIG. 31 is a perspective view of an image capturing unit according to the 11th embodiment of the present disclosure. In this embodiment, an image capturing unit 100 is a camera module including a lens unit 101, a driving device 102, an image sensor 103 and an image stabilizer 104. The lens unit 101 includes the photographing optical lens assembly as disclosed in the 1st embodiment, a barrel and a holder member (their reference numerals are omitted) for holding the photographing optical lens assembly. However, the lens unit 101 may alternatively be provided with the photographing optical lens assembly as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and different driving configurations can be achieved using lead screws, voice coil motors (VCM), micro electro-mechanical systems (MEMS), piezoelectric systems, shape memory alloys, spring type, or ball type driving systems, but the present disclosure is not limited thereto. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the photographing optical lens assembly to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic and low-light scenarios. Some movable elements in the image capturing unit 100 can be driven by the driving device 102 to compensate for image tilt in real-time, achieving optical image stabilization. For example, the driving device 102 can drive the movable elements such as the movable group of the photographing optical lens assembly and the image sensor 103 to move in directions parallel to, inclined to, or perpendicular to the optical axis. However, the present disclosure is not limited to the driving configurations mentioned above.

### 12th Embodiment

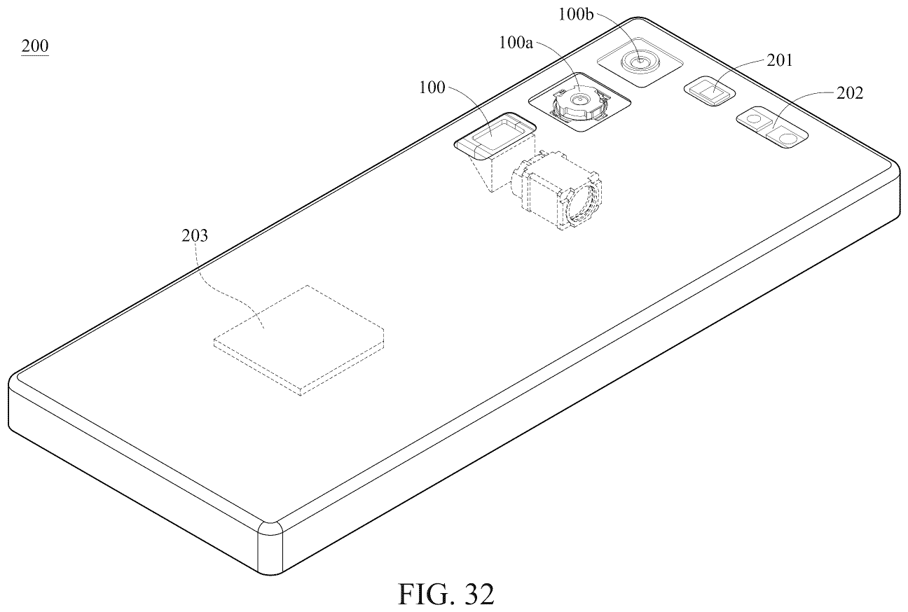

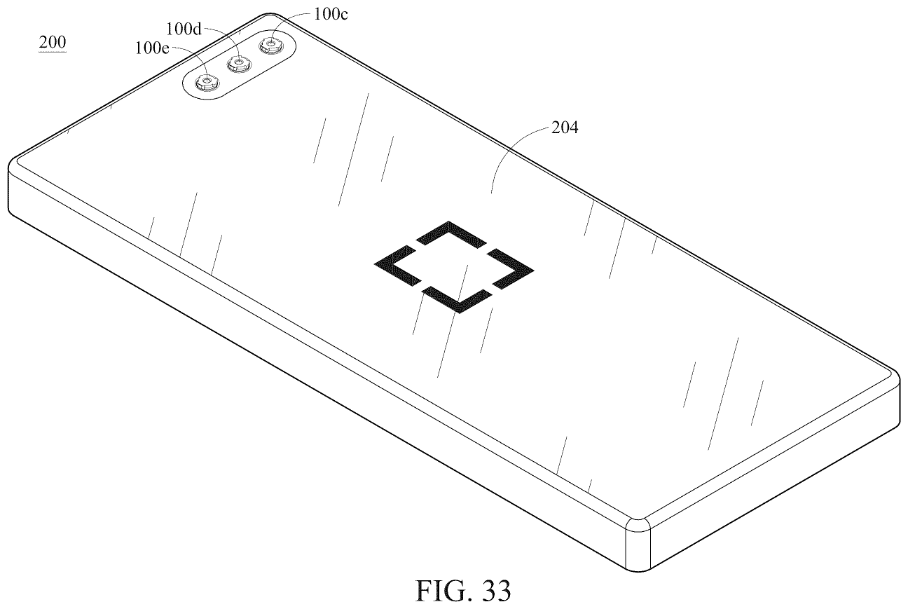

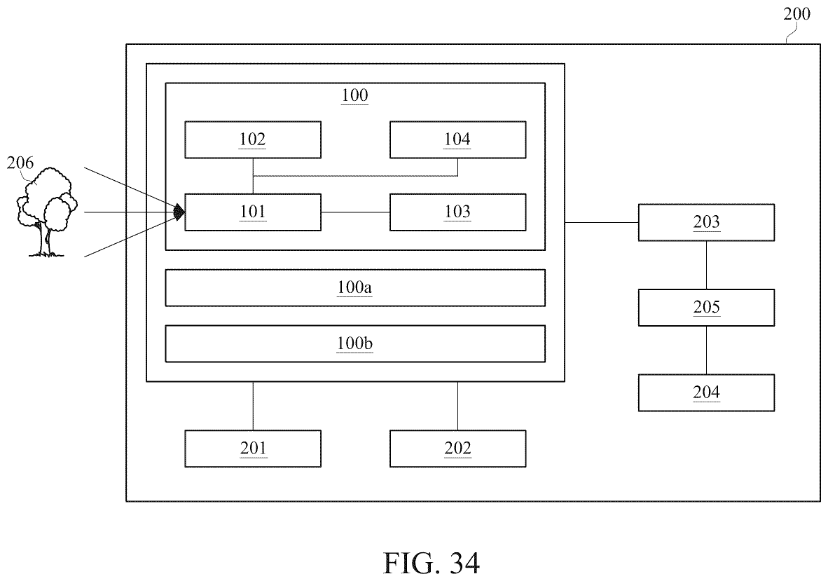

FIG. 32 is one perspective view of an electronic device according to the 12th embodiment of the present disclosure, FIG. 33 is another perspective view of the electronic device in FIG. 32, and FIG. 34 is a block diagram of the electronic device in FIG. 32.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, allowing the image capturing units 100c, 100d and 100e to serve as front-facing cameras of the electronic device 200 for taking selfies, but the present disclosure is not limited thereto. Furthermore, each of the image capturing units 100a, 100b, 100c, 100d and 100e can include the photographing optical lens assembly of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a reflective element for folding optical path. In addition, each lens unit of the image capturing units 100a, 100b, 100c, 100d and 100e can include the photographing optical lens assembly of the present disclosure, a barrel and a holder member for holding the photographing optical lens assembly.

The image capturing unit 100 is a telephoto image capturing unit with optical path folding function, the image capturing unit 100a is a wide-angle image capturing unit, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, a maximum field of view of the image capturing unit 100 and a maximum field of view of the image capturing unit 100a can differ by more than 30 degrees, and the maximum field of view of the image capturing unit 100 and a maximum field of view of the image capturing unit 100b can differ by more than 30 degrees. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

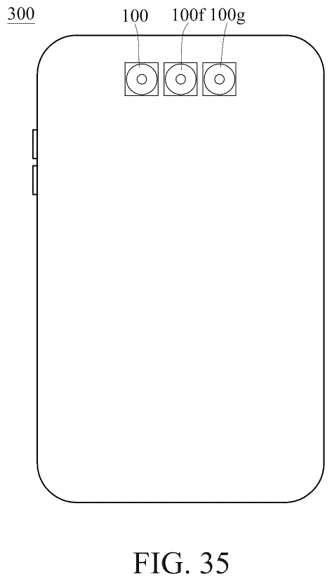

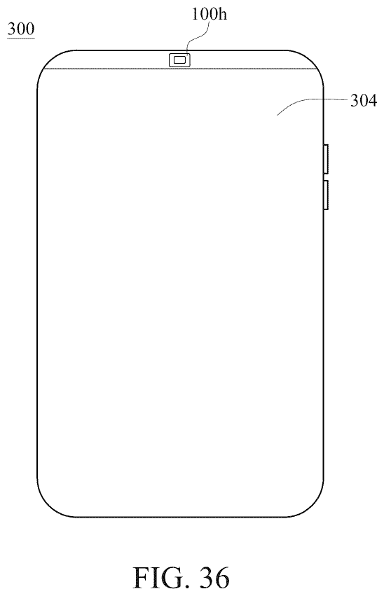

FIG. 35 is one schematic view of an electronic device according to the 13th embodiment of the present disclosure, and FIG. 36 is another schematic view of the electronic device in FIG. 35.

In this embodiment, an electronic device 300 is a smartphone including the image capturing unit 100 as disclosed in the 11th embodiment, an image capturing unit 100f, an image capturing unit 100g, an image capturing unit 100h and a display module 304. As shown in FIG. 35, the image capturing unit 100, the image capturing unit 100f and the image capturing unit 100g are disposed on the same side of the electronic device 300, and each of the image capturing units 100, 100f and 100g has a single focal point. As shown in FIG. 36, the image capturing unit 100h and the display module 304 are disposed on the opposite side of the electronic device 300, allowing the image capturing unit 100h to serve as a front-facing camera of the electronic device 300 for taking selfies, but the present disclosure is not limited thereto. Furthermore, each of the image capturing units 100f, 100g and 100h can include the photographing optical lens assembly of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the photographing optical lens assembly of the present disclosure, a barrel and a holder member for holding the photographing optical lens assembly.

The image capturing unit 100 is a telephoto image capturing unit, the image capturing unit 100f is a wide-angle image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. Moreover, a maximum field of view of the image capturing unit 100 and a maximum field of view of the image capturing unit 100f can differ by more than 30 degrees, and the maximum field of view of the image capturing unit 100 and a maximum field of view of the image capturing unit 100g can differ by more than 30 degrees. Moreover, as shown in FIG. 36, the image capturing unit 100h can have a non-circular opening, and the barrel or optical elements in the image capturing unit 100h can have trimmed edges at their outermost positions so as to coordinate with the shape of the non-circular opening. Therefore, the single-axis length of the image capturing unit 100h can be further reduced, which is favorable for reducing the size of the image capturing unit 100h so as to increase the ratio of the area of the display module 304 relative to that of the electronic device 300, and reduce the thickness of the electronic device 300, thereby achieving compactness. In this embodiment, the electronic device 300 includes multiple image capturing units 100, 100f, 100g and 100h, but the present disclosure is not limited to the number and arrangement of image capturing units.

### 14th Embodiment

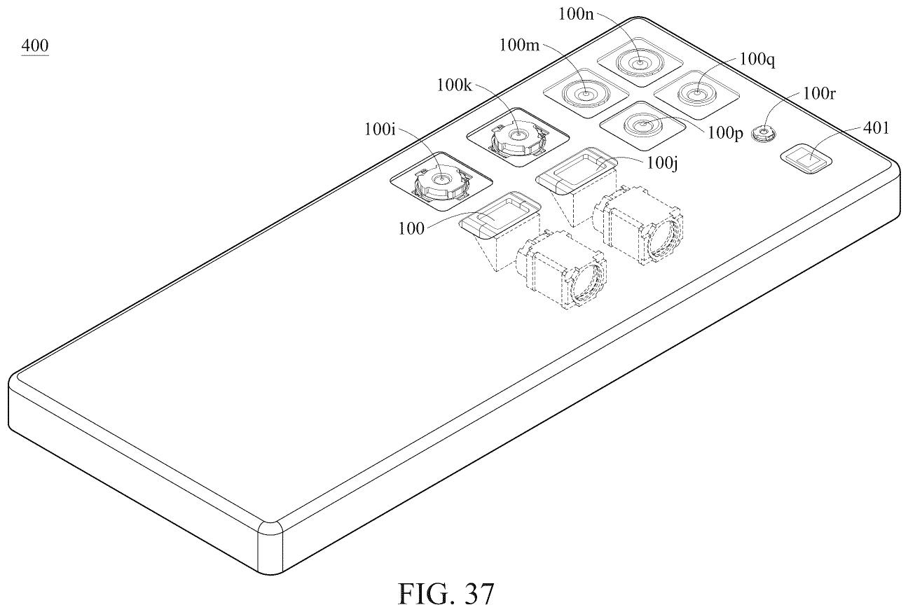

FIG. 37 is one perspective view of an electronic device according to the 14th embodiment of the present disclosure.

In this embodiment, an electronic device 400 is a smartphone including the image capturing unit 100 as disclosed in the 11th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module, and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the photographing optical lens assembly of the present disclosure and can have a configuration similar to that of the image capturing unit 100, and the details in this regard will not be provided again. The image capturing unit 100 is a telephoto image capturing unit with optical path folding function, the image capturing unit 100i is a wide-angle image capturing unit, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, a maximum field of view of the image capturing unit 100 and a maximum field of view of the image capturing unit 100i can differ by more than 30 degrees, and the maximum field of view of the image capturing unit 100 and a maximum field of view of the image capturing unit 100m can differ by more than 30 degrees. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the photographing optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders and other electronic imaging devices.

The foregoing description, for the purpose of explanation, has been described with reference to specific embodiments. It is to be noted that TABLES 1A-10C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical lens assembly comprising six optical elements, the six optical elements being, in order from an object side to an image side along an optical path, a first optical element, a second optical element, a third optical element, a fourth optical element, a fifth optical element and a sixth optical element, and each of the six optical elements having an object-side surface facing toward the object side and an image-side surface facing toward the image side;
wherein the first optical element has positive refractive power, the object-side surface of the first optical element is convex in a paraxial region thereof, the fourth optical element has positive refractive power, and the object-side surface of the fourth optical element is convex in a paraxial region thereof;
wherein a central thickness of the first optical element is CT1, a central thickness of the second optical element is CT2, a central thickness of the third optical element is CT3, a central thickness of the fourth optical element is CT4, a central thickness of the fifth optical element is CT5, a central thickness of the sixth optical element is CT6, a focal length of the photographing optical lens assembly is f, a focal length of the first optical element is f1, a curvature radius of the object-side surface of the second optical element is R3, a curvature radius of the image-side surface of the sixth optical element is R12, and the following conditions are satisfied:
$$0.45 < ( CT 2 + CT 3 + CT 4 + CT 5 + CT 6 ) / CT 1 < 1.55 ;$$
$$0. < f / f 1 < 1. ;$$
$$and$$
$$- 10. 00 < ( R 3 + R 12 ) / ( R 3 - R 12 ) < - 1.3 .$$

2. The photographing optical lens assembly of claim 1, wherein the object-side surface of the second optical element is convex in a paraxial region thereof, and the image-side surface of the sixth optical element is concave in a paraxial region thereof; and
wherein half of a maximum field of view of the photographing optical lens assembly is HFOV, and the following condition is satisfied:
$$8. degrees < HFOV < 20. degrees .$$

3. The photographing optical lens assembly of claim 1, wherein a sum of axial distances between each of all adjacent optical elements of the photographing optical lens assembly is ΣAT, an axial distance between the image-side surface of the sixth optical element and an image surface is BL, a sum of central thicknesses of all optical elements of the photographing optical lens assembly is ΣCT, and the following condition is satisfied:
$$0.4 < ( \sum AT + BL ) / \sum CT < 1.6 .$$

4. The photographing optical lens assembly of claim 1, further comprising an aperture stop, wherein the focal length of the photographing optical lens assembly is f, a composite focal length of the second optical element and the third optical element is f23, an entrance pupil diameter of the photographing optical lens assembly corresponding to a maximum entrance pupil diameter direction of the aperture stop is EPDmax, and the following conditions are satisfied:
$$1.6 < f / EPD max < 3 \text{.60} ;$$
$$and$$
$$- 2.2 < f / f 23 < 0.60 .$$

5. The photographing optical lens assembly of claim 1, wherein the focal length of the photographing optical lens assembly is f, a focal length of the fourth optical element is f4, and the following condition is satisfied:
$$0.03 < f 4 / f < 1.8 .$$

6. The photographing optical lens assembly of claim 1, wherein a curvature radius of the image-side surface of the first optical element is R2, the curvature radius of the object-side surface of the second optical element is R3, and the following condition is satisfied:
$$0. \leq \vert R 3 / R 2 \vert < 0. 30 .$$

7. The photographing optical lens assembly of claim 1, wherein a curvature radius of the object-side surface of the first optical element is R1, a curvature radius of the object-side surface of the fourth optical element is R7, and the following condition is satisfied:
$$0. \leq \vert R 7 / R 1 \vert < 1. .$$

8. The photographing optical lens assembly of claim 1, wherein a curvature radius of the object-side surface of the fourth optical element is R7, a curvature radius of the object-side surface of the fifth optical element is R9, and the following condition is satisfied:
$$- 2.00 < ( R 7 + R 9 ) / ( R 7 - R 9 ) < 0.30 .$$

9. The photographing optical lens assembly of claim 1, wherein an Abbe number of the fifth optical element is V5, an Abbe number of the sixth optical element is V6, a refractive index of the fourth optical element is N4, and the following conditions are satisfied:
$$0.9 < V 5 / N 6 < 5 \text{.00} ;$$
$$and$$
$$1.45 < N 4 < 1.58 0 .$$

10. The photographing optical lens assembly of claim 1, wherein the first optical element is a prism, and the first optical element has a reflective surface; and
wherein a refractive index of the first optical element is N1, the central thickness of the first optical element is CT1, the central thickness of the second optical element is CT2, the central thickness of the third optical element is CT3, the central thickness of the fourth optical element is CT4, the central thickness of the fifth optical element is CT5, the central thickness of the sixth optical element is CT6, and the following conditions are satisfied:
$$1.5 < N 1 < 1.6 ;$$
$$and$$
$$0.55 < ( CT 2 + CT 3 + CT 4 + CT 5 + CT 6 ) / CT 1 < 1.45 .$$

11. The photographing optical lens assembly of claim 1, wherein a displacement in parallel with an optical axis from an axial vertex of the object-side surface of the first optical element to a maximum effective radius position of the object-side surface of the first optical element is SAG1R1, a displacement in parallel with the optical axis from an axial vertex of the image-side surface of the first optical element to a maximum effective radius position of the image-side surface of the first optical element is SAG1R2, a distance in parallel with the optical axis between the maximum effective radius position of the object-side surface of the first optical element and the maximum effective radius position of the image-side surface of the first optical element is ET1, and the following condition is satisfied:
$$- 0.10 < ( SAG 1 R 1 + SAG 1 R 2 ) / ET 1 < 0.35 .$$

12. An image capturing unit comprising:
the photographing optical lens assembly of claim 1; and
an image sensor disposed on an image surface of the photographing optical lens assembly.

13. An electronic device comprising at least two image capturing units,
wherein the at least two image capturing units are located on a same side of the electronic device, and the at least two image capturing units comprises:
a first image capturing unit comprising the image capturing unit of claim 12; and
a second image capturing unit comprising an optical lens assembly and an image sensor disposed on an image surface of the optical lens assembly;
wherein a maximum field of view of the first image capturing unit and a maximum field of view of the second image capturing unit differ by more than 30 degrees.

14. A photographing optical lens assembly comprising six optical elements, the six optical elements being, in order from an object side to an image side along an optical path, a first optical element, a second optical element, a third optical element, a fourth optical element, a fifth optical element and a sixth optical element, and each of the six optical elements having an object-side surface facing toward the object side and an image-side surface facing toward the image side;
wherein the first optical element has positive refractive power, the object-side surface of the first optical element is convex in a paraxial region thereof, the fourth optical element has positive refractive power, and the object-side surface of the fourth optical element is convex in a paraxial region thereof;
wherein a central thickness of the first optical element is CT1, a central thickness of the second optical element is CT2, a central thickness of the third optical element is CT3, a central thickness of the fourth optical element is CT4, a central thickness of the fifth optical element is CT5, a central thickness of the sixth optical element is CT6, a focal length of the photographing optical lens assembly is f, a focal length of the first optical element is f1, a composite focal length of the fifth optical element and the sixth optical element is f56, a curvature radius of the image-side surface of the first optical element is R2, a curvature radius of the object-side surface of the fourth optical element is R7, and the following conditions are satisfied:
$$0.4 < ( CT 2 + CT 3 + CT 4 + CT 5 + CT 6 ) / CT 1 < 1.6 ;$$
$$0. < f / f 1 < 0.9 ;$$
$$- 3. 0 < f / f 56 < - 0 \text{.65} ;$$
$$and$$
$$0. \leq \vert R 7 / R 2 \vert < 0. 80 .$$

15. The photographing optical lens assembly of claim 14, wherein the object-side surface of the second optical element is convex in a paraxial region thereof, and the image-side surface of the sixth optical element is concave in a paraxial region thereof.

16. The photographing optical lens assembly of claim 14, wherein the curvature radius of the image-side surface of the first optical element is R2, the curvature radius of the object-side surface of the fourth optical element is R7, a curvature radius of the object-side surface of the fifth optical element is R9, and the following condition is satisfied:
$$0.01 < ( \vert R 7 \vert + \vert R 9 \vert ) / \vert R 2 \vert < 2. 00 .$$

17. The photographing optical lens assembly of claim 14, wherein the curvature radius of the object-side surface of the fourth optical element is R7, a curvature radius of the image-side surface of the sixth optical element is R12, a maximum effective radius of the object-side surface of the first optical element is Y1R1, a maximum image height of the photographing optical lens assembly is ImgH, and the following conditions are satisfied:
$$1. 60 < R 12 / R 7 < 8. ;$$
$$and$$
$$0.8 < Y 1 R 1 / ImgH < 1.6 .$$

18. The photographing optical lens assembly of claim 14, wherein the central thickness of the first optical element is CT1, the central thickness of the third optical element is CT3, and the following condition is satisfied:
$$0.1 < 10 \times CT 3 / CT 1 < 3.00 .$$

19. The photographing optical lens assembly of claim 14, further comprising an aperture stop, wherein the central thickness of the third optical element is CT3, the focal length of the photographing optical lens assembly is f, an entrance pupil diameter of the photographing optical lens assembly corresponding to a maximum entrance pupil diameter direction of the aperture stop is EPDmax, and the following conditions are satisfied:
$$0.15 < 10 \times CT 3 / f < 0.6 ;$$
$$and$$
$$1. 80 < f / EPDmax < 3.30 .$$

20. The photographing optical lens assembly of claim 14, wherein a refractive index of the second optical element is N2, the curvature radius of the image-side surface of the first optical element is R2, the curvature radius of the object-side surface of the fourth optical element is R7, and the following conditions are satisfied:
$$1.42 < N 2 < 1.62 ;$$
$$and$$
$$0.01 < \vert R 7 / R 2 \vert < 0. 40 .$$

21. The photographing optical lens assembly of claim 14, wherein the focal length of the photographing optical lens assembly is f, a focal length of the fourth optical element is f4, and the following condition is satisfied:
$$0.06 < f 4 / f < 1.1 .$$

22. The photographing optical lens assembly of claim 14, wherein at least one of the six optical elements has at least one inflection point; and
wherein a sum of axial distances between each of all adjacent optical elements of the photographing optical lens assembly is ΣAT, an axial distance between the image-side surface of the sixth optical element and an image surface is BL, a sum of central thicknesses of all optical elements of the photographing optical lens assembly is ΣCT, and the following condition is satisfied:
$$0.5 < ( \sum AT + BL ) / \sum CT < 1.4 .$$

23. The photographing optical lens assembly of claim 14, wherein the focal length of the photographing optical lens assembly is f, a focal length of the fifth optical element is f5, a focal length of the sixth optical element is f6, and the following condition is satisfied:
$$- 2.50 < f / f 5 + f / f 6 < - 0.80 .$$

24. The photographing optical lens assembly of claim 14, wherein a curvature radius of the image-side surface of the fifth optical element is R10, a focal length of the sixth optical element is f6, and the following condition is satisfied:
$$- 0.25 < R 10 / f 6 < 10.00 .$$

25. The photographing optical lens assembly of claim 14, wherein an axial distance between the second optical element and the third optical element is T23, the central thickness of the second optical element is CT2, and the following condition is satisfied:
$$0.1 < T 23 / CT 2 < 0.80 .$$

26. The photographing optical lens assembly of claim 14, wherein the first optical element has a reflective surface; and
wherein an axial distance between the reflective surface of the first optical element and an image surface is P1TL, an axial distance between the object-side surface of the first optical element and the image surface is TL, a displacement in parallel with an optical axis from an axial vertex of the object-side surface of the fifth optical element to a maximum effective radius position of the object-side surface of the fifth optical element is SAG5R1, a displacement in parallel with the optical axis from an axial vertex of the image-side surface of the fifth optical element to a maximum effective radius position of the image-side surface of the fifth optical element is SAG5R2, the central thickness of the fifth optical element is CT5, and the following conditions are satisfied:
$$0.7 < P 1 TL / TL < 0.95 ;$$
$$and$$
$$- 1.1 < ( SAG 5 R 1 + SAG 5 R 2 ) / CT 5 < 0.80 .$$

27. The photographing optical lens assembly of claim 14, wherein a displacement in parallel with an optical axis from an axial vertex of the image-side surface of the sixth optical element to a maximum effective radius position of the image-side surface of the sixth optical element is SAG6R2, the central thickness of the sixth optical element is CT6, and the following condition is satisfied:
$$- 0.50 < SAG 6 R 2 / CT 6 < 0.80 .$$

28. The photographing optical lens assembly of claim 14, wherein the central thickness of the first optical element is CT1, the central thickness of the second optical element is CT2, the central thickness of the third optical element is CT3, the central thickness of the fourth optical element is CT4, the central thickness of the fifth optical element is CT5, the central thickness of the sixth optical element is CT6, the focal length of the photographing optical lens assembly is f, the focal length of the first optical element is f1, the composite focal length of the fifth optical element and the sixth optical element is f56, the curvature radius of the image-side surface of the first optical element is R2, a curvature radius of the object-side surface of the second optical element is R3, the curvature radius of the object-side surface of the fourth optical element is R7, a curvature radius of the image-side surface of the sixth optical element is R12, and the following conditions are satisfied:
$$0.78 \leq ( CT 2 + CT 3 + CT 4 + CT 5 + CT 6 ) / CT 1 \leq 1.23 ;$$
$$0.33 \leq f / f 1 \leq 0.64 ;$$
$$- 2. 6 \leq f / f 56 \leq - 1.09 ;$$
$$- 5.9 \; 4 \leq ( R 3 + R 12 ) / ( R 3 - R 12 ) \leq - 1.63 ;$$
$$and$$
$$0.02 \leq \vert R 7 / R 2 \vert \leq 0. 18 .$$
